(19) United States
(12) Patent Application Publication
(10) Pub. No.: US 2026/0123645 A1
(43) Pub. Date: May 7, 2026

(54) GUM ACACIA-FREE AND WEIGHTING AGENT-FREE EMULSIONS

(71) Applicant: Abstrax Tech Inc., Tustin, CA (US)

(72) Inventors: Marcos A. Ojeda, Tustin, CA (US); Marlene A. McGorrin, Tustin, CA (US); Iain W.H. Oswald, Tustin, CA (US); Thomas J. Martin, Jr., Tustin, CA (US); Kevin A. Koby, Tustin, CA (US)

(21) Appl. No.: 19/380,026

(22) Filed: Nov. 5, 2025

Related U.S. Application Data
(60) Provisional application No. 63/717,204, filed on Nov. 6, 2024.

(51) Int. Cl. A23D 7/005; A23D 7/01; A23D 7/04; A23F 3/40; A23L 27/00; A23L 27/10; C12C 5/02; C12G 1/00; C12G 3/06

(52) U.S. Cl. CPC A23D 7/0053; A23D 7/011; A23D 7/04; A23F 3/405; A23L 27/10; A23L 27/80; C12C 5/026; C12G 1/00; C12G 3/06; C12G 2200/21

(57) ABSTRACT

Compositions in the form of an oil-in-water emulsion composition include an oil phase that includes a flavorant, and optionally an emulsifier adjuvant; and a continuous aqueous phase that includes water, an emulsifier adjuvant and an emulsifying agent, wherein the oil-in-water emulsion composition is substantially free of weighting agents and/or gum acacia.

### CROSS REFERENCE TO RELATED APPLICATIONS

This application claims the benefit of U.S. Provisional Application No. 63/717,204, filed Nov. 6, 2024, the disclosure of which is incorporated herein by reference in its entirety.

### FIELD

The present technology generally relates to compositions and methods that can be used to provide additional enhancements to the texture, appearance, stability, and shelf-life of consumable and topically applied substances. In particular, the present technology relates to various compositions, products, and methods involving oil-in-water emulsions that provide aroma and flavor enhancement of consumable substances, including beverages and foods.

### BACKGROUND

The following discussion is provided to aid the reader in understanding the disclosure and is not admitted to describe or include prior art thereto.

Emulsifiers, hydrocolloids, and other stabilizers play important roles in the manufacture and stability of beverages. These components are used to prevent separation, enhance flavor, texture, and appearance, and to ensure the consistent dispersion of flavors and aromas, and the quality and stability of beverages during shelf-life. Flavors and sweeteners added to beverages may first be incorporated into an emulsion and then added to the beverage, to provide improvements in many of these attributes.

Consumer demand for natural and organic food and beverage ingredients and products has created a need for natural alternatives that can successfully be used to replace traditionally used synthetic emulsifiers, hydrocolloids, and stabilizers.

Flavorant or fragrance emulsions, particularly oil-in-water emulsions, are widely used in the food and beverage industry to provide consistent flavor and aroma. Traditional methods for preparing oil-in-water emulsions typically require the use of weighting agents, such as ester gum and brominated vegetable oil (BVO), to achieve the desired density and stability. However, weighting agents may be viewed as a health concern by consumers and the regulatory limits on weighting agent usage level make their use difficult. Moreover, weighting agents are expensive and contribute significantly to the formulation cost of the emulsion, and their use results in a time consuming and inefficient process which requires dissolving weighting agent. Additionally, when used in beverages, such as alcoholic beverages, weighting agents cause undesirable turbidity and sedimentation. Weighting agents may therefore pose disadvantages including undesirable attributes such as regulatory challenges, prolonged processing times, clean up times and difficulty between batches increased costs, turbidity, and sedimentation.

Therefore, there is a need for an approach to prepare stable emulsions without the need for weighting agents, density matching agents, or other components that are used to match the oil and aqueous phase densities, but which have an adverse effect on overall quality and consistency of the final products. There is also a need to prepare stable emulsions without gums such as gum acacia. The use of these gums requires a gum pre-hydration step in preparation of the water phase and longer processing times. Additionally, gums are expensive and frequently suffer from quality variability and availability issues as well as increased costs.

### SUMMARY

According to a first aspect, an oil-in-water emulsion composition includes an oil phase that includes about 0.01 wt. % to about 30 wt. %, based on a total weight of the emulsion composition, of a flavorant; and about 0.01 wt. % to about 10 wt. %, based on the total weight of the emulsion composition, of an emulsifier adjuvant; and a continuous aqueous phase of water and about 0.01 wt. % to about 10 wt. %, based on the total weight of the emulsion composition, of an emulsifying agent, wherein the oil-in-water emulsion composition is substantially free of weighting agents and/or gum acacia. In some embodiments, the oil-in-water emulsion composition includes an oil phase that includes about 0.01 wt. % to about 10 wt. %, based on the total weight of the emulsion composition, of a flavorant.

In some embodiments, the flavorant in the oil-in-water emulsion composition includes hop oil, cannabis oil, hemp oil, hop extract, carrier oil, flavorant blends, hop-derived flavorant compounds, non-hop derived flavorant compounds, or a mixture of any two or more thereof. In some embodiments, the flavorant comprises one or more terpene, terpene blends, thiols, ketones, esters, aldehydes, alcohols, polyfunctional alcohols, polyfunctional thiols, heterocycles, and phenolics. In some embodiments the flavorant comprises terpenes and non-terpenes. In some embodiments, the oil-in-water emulsion composition comprises from about 0.05% to about 8% by weight, based on the total weight of the emulsion composition, of the flavorant.

In some embodiments, the emulsifier adjuvant in the oil-in-water emulsion composition may be citric acid, malic acid, tartaric acid, ascorbic acid, caffeic acid, ferulic acid, and salts thereof. In some embodiments, the emulsifier adjuvant includes sugars. In some embodiments, the emulsifier adjuvant includes one or more of lactose, maltose, sucrose, trehalose, dulcitol, glycerol, mannitol and sorbitol. In some embodiments, the emulsifier adjuvants includes trehalose. In some embodiments, the oil-in-water emulsion composition comprises about 0.01% to about 15% by weight of the total weight of the emulsion composition of the emulsifier adjuvant.

In some embodiments, the emulsifying agent in the oil-in-water emulsion composition includes a phospholipid, potassium sorbate, sorbitan monooleate, sorbitan monolaurate, sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and a combination of any two or more thereof. In some embodiments, the emulsifying agent comprises a sunflower lecithin. In other embodiments, the oil-in-water emulsion composition may include one or more components such as sunflower oil, medium chain triglycerides, trehalose, and sucrose.

In some embodiments, the water is present in an amount corresponding to the remaining balance of material in the oil-in-water emulsion composition, after taking into account all other components. In some embodiments, the oil-in-water emulsion composition is free of a weighting agent. In some embodiments, the oil-in-water emulsion composition is free of gum acacia. In some embodiments, the oil-in-water emulsion composition is free of polysorbates. In some embodiments, the oil-in-water emulsion composition is free of quillaja. In some embodiments, the oil-in-water emulsion composition exhibits reduction in particle size and/or particle size range, lower turbidity, pH stability, increased stability during storage and shelf life as compared to an otherwise identical formulated composition containing a weighting agent, gum acacia, or a mixture thereof.

According to another aspect, provided is a product which includes the oil-in-water emulsion compositions. In some embodiments, the product is an edible product, a flavor product, or a fragrance product. In some embodiments, the edible product is a food or beverage product. In some embodiments, the beverage is beer, an alcohol containing beverage, or a non-alcohol containing beverage product. In some embodiments, the beverage product is a fermented beverage. In some embodiments, the fermented beverage may be kombucha, beer, wine, or cider.

According to yet another aspect, provided is an oil-in-water emulsion composition which includes about 0.5 wt. % to about 8 wt. %, based on a total weight of the emulsion composition, of a flavorant; about 0.01 wt. % to about 5 wt. %, based on the total weight of the emulsion composition, of a sunflower lecithin; about 0.01 wt. % to about 0.1 wt. %, based on the total weight of the emulsion composition, of citric acid; and water in an amount corresponding to the remaining balance based on the total weight of the oil-in-water emulsion composition, wherein the oil-in-water emulsion composition is substantially free of a weighting agent and/or gum acacia. In some embodiments, the oil-in-water emulsion composition exhibits improved stability as compared to an identically formulated composition containing a weighting agent and/or gum acacia. In some embodiments, the flavorant comprises a terpene or a terpene blend. In some embodiments, the emulsifier adjuvant includes trehalose.

According to yet another aspect, provided is a method which includes: (i) providing an oil phase comprising a flavorant; (ii) providing an aqueous phase comprising water, one or more emulsifying agents, and one or more emulsifier adjuvants; (iii) mixing the oil phase and the aqueous phase to obtain a pre-emulsion; and (iv) homogenizing the pre-emulsion to obtain an oil-in-water emulsion; wherein the oil-in-water emulsion is substantially free of weighting agents and/or gum acacia. In some embodiments, the homogenizing comprises a multi-stage homogenization process.

According to another aspect, provided is a method which includes: (i) providing an oil phase comprising a flavorant and optionally an emulsifier adjuvant; (ii) providing an aqueous phase comprising water, one or more emulsifying agents, and one or more emulsifier adjuvant; (iii) mixing the oil phase and the aqueous phase to obtain a pre-emulsion; and (iv) homogenizing the pre-emulsion to obtain an oil-in-water emulsion; wherein the oil-in-water emulsion is substantially free of weighting agents and/or gum acacia. In some embodiments, the homogenizing comprises a multi-stage homogenization process.

According to one aspect, provided is a method which includes plating the oil-in-water emulsion composition onto wet or dry surfaces of an edible layer or film; and processing the edible layer or film to provide consumable product. In another aspect, provided is a method which includes plating the oil-in-water emulsion composition onto wet or dry particles; and processing the dry particles to provide consumable product. In yet another aspect, provided is a method which includes plating the oil-in-water emulsion composition onto wet or dry surfaces of an edible film or layer, or onto wet or dry particles; treating and drying the film, layer or particles, and processing the dry particles or film to provide consumable product. In some embodiments, the treating includes coating with another layer, agglomeration, encapsulation, or a combination of any two or more thereof. In some embodiments, the consumable product is a food or beverage product.

### BRIEF DESCRIPTION OF THE DRAWINGS

FIG. 1A and FIG. 1B are flowcharts showing a representative creation scheme of weighting agent-free emulsions and weighting agent-containing emulsions, respectively.

FIG. 2 is a Gantt chart showing time savings for the gum-free emulsion process depicted in FIG. 1 A compared to the conventional, weighting agent-containing emulsion process depicted in FIG. 1B.

FIG. 3A and FIG. 3B are graphs showing particle size measurements (d90) and (d50), respectively, versus time for oil-in-water emulsions containing Flavorant A during accelerated storage shelf-lie testing at 45° C., in an embodiment of the present technology.

FIG. 4A and FIG. 4B are graphs showing particle size measurements (d90) and (d50), respectively, versus time for oil-in-water emulsions containing Flavorant B during accelerated storage shelf-lie testing at 45° C., in an embodiment of the present technology.

FIG. 5A and FIG. 5B are graphs showing particle size measurements (d90) and (d50), respectively, versus time for oil-in-water emulsions containing Flavorant C during accelerated storage shelf-lie testing at 45° C., in an embodiment of the present technology.

FIG. 6A and FIG. 6B are graphs showing particle size measurements (d90) and (d50), respectively, versus time for oil-in-water emulsions containing Flavorant D during accelerated storage shelf-lie testing at 45° C., in an embodiment of the present technology.

FIG. 7A and FIG. 7B are graphs showing particle size measurements (d90) and (d50), respectively, versus time for oil-in-water emulsions containing Flavorant E during accelerated storage shelf-lie testing at 45° C., in an embodiment of the present technology.

FIGS. 8A-8H are bar graphs showing quantitative comparison of various sensory scores across six illustrative emulsion compositions, a control composition containing weighting agent (EMP-01A) and inventive compositions free of weighting agents (EMP-01B-EMP-01F).

FIGS. 9A-9F show radar (spider) charts demonstrating the sensory profiles of six illustrative emulsion compositions for both a control composition containing weighting agent (EMP-01A) and inventive compositions free of weighting agents (EMP-01B-EMP-01F).

FIGS. 10A-10N illustrates graphs for headspace analysis showing peak intensities for key volatiles in illustrative emulsion compositions for both a control composition containing weighting agent (EMP-01A) and inventive compositions free of weighting agents (EMP-01B-EMP-01F).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. As a non-limiting example, a reference to “X and/or Y” can refer, in some embodiments, to X only (optionally including elements other than Y); in another embodiment, to Y only (optionally including elements other than X); in yet another embodiment, to both X and Y (optionally including other elements).

Unless indicated otherwise, reference to “percent” is to be understood as “weight percent,” and reference to “ratio” is as a weight/weight ratio.

As used herein, the term “terpene compound” is understood to mean any organic compound that contains some isoprene subunit within its structure and their oxygenated derivatives.

As used herein, the terms “odor” and “aroma” are used interchangeably and represent the sensory attributes of certain substances perceptibly determined by the olfactory system.

As used herein, the term “emulsion” refers to a class of disperse systems containing two immiscible liquids (e.g., oil and water), with one of the liquids being dispersed as small spherical droplets (the dispersed phase) in the other (the continuous phase). Emulsions can be characterized by the nature of the emulsifier, the structure or of the emulsion or both. Representative emulsions by structure include oil-in-water (o/w) emulsions, water-in-oil (w/o) emulsions and oil-in-oil (w/o) emulsions.

As used herein, the term “oil-in-water emulsion” or “o/w emulsion” refers to a composition where small droplets of oil are immersed in water or another liquid. Oil is therefore the dispersed phase, while water is the dispersion medium.

As used herein, the term “water-in-oil emulsion” or “w/o emulsion” refers to a composition where small droplets of water are immersed in oil or another liquid. Water is therefore the dispersed phase, while oil is the dispersion medium.

The term “flavorant emulsion” as used herein refers to an emulsion in which one or more flavorants and/or flavorants are incorporated.

The term “emulsifier adjuvant” as used herein refers to an agent present in either the oil phase or water phase or both that enhances and/or modifies the action and/or effectiveness of an emulsifier.

As used herein, the term “flavoring agent” or “flavorant” is understood to mean a substance that is meant to impart and/or improve the flavor (taste) and/or aroma impression of substances e.g., food or other substances, and can include both natural and synthetic ingredients. For example, a flavorant can include an aroma and/or a flavor agent. The flavorants may include additional additive(s) that provide additional functional benefits.

The term “flavor enhancer” as used herein refers to substances added to supplement, enhance, or modify the original taste and/or aroma of a food, without imparting a characteristic taste or aroma of its own.

The term “full spectrum hop extract” as used herein refers to a hop material that has not been separated beyond the initial extract produced from the extraction process.

As used herein, the term “substantially free” may refer to a composition that has little or no content of the stated component. For instance, “substantially free of weighting agent” refers to a composition that has little or no weighting agent, e.g., the content of weighting agent is less than about 0.1 wt. %, less than about 0.01 wt. %, less than about 0.001 wt. %, or less than about 0.0001 wt. % based on the weight of the composition. In some embodiments, the composition is free of the stated component.

As used here, the term “weighting agent” has its ordinary meaning to those skilled in the art. In general, it refers to an additive that is used to increase the density of a composition, and which aids in keeping an ingredient homogenously dispersed or suspended in the emulsion. As an example, a weighting agent can be an additive incorporated into the oil phase of certain types of emulsions to inhibit gravitational separation of the oil droplets from the water phase (i.e., aqueous phase).

Weighting agents, also known as density matching agents, are compounds which are used to match the oil and aqueous phase densities in oil-water emulsions. Commonly used weighting agents include, but are not limited to brominated vegetable oil (BVO), glycerol ester of wood rosin/glyceryl abietate (ester gum), sucrose acetate isbutyrate (SAIB), sucrose octa-isobutyrate, sucrose octa-acetate, sucrose hepta-isobutyrate, sucrose octa-propionate, propylene glycol dibenzoate, glycerol tribenzoate, methyl ester of hydrogenated rosin, calcium carbonate, manganese tetraoxide, and combinations thereof. Weighting agents are commonly used in emulsions to increase the density of a composition and potentially contribute to the stabilization of an emulsion through minimization of the difference in density between the different phases. Generally, weighting agents are oil soluble and have a specific gravity greater than oil, and they generally function by increasing the density of the oil phase and decreasing the likelihood of phase separation. However, commonly used weighting agents such as ester gum, BVO and SAIB, and other ingredients such as polysorbates and quilaja, are known to have several drawbacks such as regulatory limits, increased processing times, turbidity, and sensory and/or regulatory issues. Furthermore, ester gums often require heating of the solution to expedite dissolution into the aqueous phase, or extended periods of time to dissolve at lower temperatures, and cause sedimentation issues and sticking during processing which could cause uneven mixing or even lead to operator injuries from the build-up. Typically, conventional preparation of oil-in-water emulsions faces several challenges:
(i) Dependency on Weighting Agents: Traditional methods rely heavily on weighting agents like ester gum and BVO to correct the density of the oil phase, which can complicate the formulation process and introduce unwanted turbidity.
(ii) Extended Processing Time: Ingredients like gum acacia require lengthy hydration steps before emulsification, significantly increasing the total processing time.
(iii) Cleaning of apparatus: Gums tend to coat the surface of the container which they are being used to product the emulsion. This leads to long times between production of different emulsions due to the nature of the gums.
(iv) Regulatory Compliance: The use of certain weighting agents and emulsifiers, such as BVO, may face regulatory restrictions and health concerns, limiting their applicability in food and beverage products.
(v) Cost and Availability: Ingredients such as gum acacia and ester gum are not only expensive but also subject to variable availability, impacting production costs and consistency.
(vi) Flavor and Aroma Loss: Traditional emulsification methods can result in the loss of volatile flavor and aroma compounds, reducing the overall sensory quality of the final product. For example, high relative volatility or reactive compounds in the flavorant system are prone to chemical or physical changes resulting in an unbalanced flavor profile. Further, the compounds in the flavor composition may react during emulsification at elevated temperatures.
(vii) Emulsion stability: Gums are prone to sedimentation due to reactivity in certain matrices containing macromolecules such as proteins in beer or other fermented products. Gum acai is also prone to sedimentation and flocculation in solutions containing high alcohol content (>10% ethanol).

The present inventors have surprisingly and unexpectedly discovered that at least some of the problems discussed above with respect to the use of weighting agents may be addressed by providing stable emulsion compositions which do not use any weighting agents. The inventors found that stable emulsions can be achieved without correcting the density, and without the need for conventional weighting agents or extended processing times. Advantageously, the inventors discovered that weighting agents can be eliminated by instead adding a flavorant to the emulsion and tailoring the flavorant (e.g., a flavorant blend) with one or more emulsifier adjuvants (i.e., agents that enhance and/or modify the action and/or effectiveness of an emulsifier) to create an oil phase. Separately, water can be mixed with the emulsifying agent(s), with or without emulsifier adjuvants, to create an aqueous phase. In some cases a specific component of the emulsion can be multifunctional, providing more than one performance attribute within the emulsion (e.g., aid ease of emulsion formation during processing, increase emulsion stability post-processing, modulate finished emulsion physical and/or chemical properties, and when added to a food or beverage enhance the physical and/or chemical and/or sensory properties of the food or beverage, etc.)

In sharp contrast to conventional preparation of oil-in-water emulsions, it was surprisingly found by the inventors that the emulsification of either flavor additives can be achieved without correcting the density. Using the formulations, processing steps, and conditions of the methods described herein, weighting agents can be eliminated from the formula by first obtaining and tailoring the flavorant additive (e.g., a flavor blend) using one or more “emulsifier adjuvants” (an agent present in either the oil phase or water phase that enhances and/or modifies the action and/or effectiveness of an emulsifier) to create an oil phase. Separately, water may be mixed with one or more emulsifying agents, with or without emulsifier adjuvants, to create a water phase (i.e., aqueous phase). The “emulsifier adjuvants” in this disclosure include, but are not limited to, acids, salts, components of hop materials, and other emulsion formulation components. They can be introduced separately in either the oil phase or the water phase prior to forming the emulsion. They also can be introduced simultaneously in both the oil phase and the water phase prior to forming the emulsion. Some of the benefits include but are not limited to, elimination of weighting agents, elimination of gums, reduced turbidity, enhanced ease of emulsion formation, increased emulsion stability, decreased loss of flavor volatiles, extended emulsion stability, and extended shelf-life. In accordance with some embodiments of the present technology, weighting agents and gums such as gum acacia can be eliminated from the flavor emulsion formulation, allowing the achievement of both enhanced flavors and flavor emulsion stability in clear beverages. The elimination of weighting agents and gums from the formulation, allows a more streamlined and efficient process, less ingredients, and less loss of flavor volatiles. The use of restricted ingredients such as BVO is avoided, enabling regulatory compliance. Reliance on increasingly expensive and unsure availability of ingredients such as ester gum or rosin is avoided. Other ingredients such as polysorbates and quillaja can also be limited or eliminated. As a direct result of the present technology, the costs for producing these flavor emulsions is advantageously reduced.

The present invention is predicated on the surprising discovery by the inventors that emulsions that meet or exceed the stability of conventional systems can be obtained, without density matching or using gum acacia, by performing one or more of the following steps: (i) tailoring the oil phase with a flavorant (and a low level of an emulsifier adjuvant), and (ii) dispersing that oil phase into an aqueous phase containing a phospholipid emulsifier, followed by (iii) controlled two stage homogenization.

Disclosed are oil-in-water emulsions, compositions, consumer products including such emulsion compositions, and methods of preparation of such emulsion compositions. In some embodiments, the emulsion compositions include an oil phase comprising a flavorant and optionally an emulsifier adjuvants; and a continuous aqueous phase comprising water and an emulsifying agents.

In some embodiments, the emulsion compositions described herein are substantially free of a weighting agent and/or gum acacia. In some embodiments, the emulsion compositions contains less than about 0.1 wt. %, less than about 0.01 wt. %, less than about 0.001 wt. %, or less than about 0.0001 wt. %, of the weighting agent (e.g., ester gum, BVO, SATB, etc.) and/or gum acacia. In some embodiments, the emulsion compositions described herein are free any weighting agent and/or gum acacia, meaning that the weighting agent (e.g., ester gum, BVO, SAIB, etc.) and/or gum acacia is completely absent from the emulsion composition or that the emulsion composition includes 0 wt. % of a weighting agent.

The emulsion compositions may include a flavorant. They can be used as such or diluted in a suitable carrier including but not limited to triacetin, triethyl citrate, limonene, or other common carriers. Suitable flavorants may include natural, plant-derived compounds or synthetic compounds, and are derived or prepared based on certain specific desired taste and/or aroma characteristics. For example, certain flavorants are derived from a plant of Humulus lupulus or from Cannabis sativa. Certain flavorants are derived from or created to mimic the flavorants of products such as fruits, spices, herbs, flowers and the like, or combinations thereof. For example, the flavorant can be selected, e.g., based on the desired aroma and/or flavor characteristics (e.g., fruity, citrus-like, flowery, spicy/herbal, tropical, earthy, piney, and the like).

In some embodiments, the flavorant may include an unmodified or modified or product of an extract. In some embodiments, the flavorant may include an unmodified or modified hop extract. In some embodiments, the flava orant may include raw hop extract (i.e., unrefined as in they were not separated it into parts, such as the terpene fraction, acid fraction, etc.), In some embodiments, the flavorant may include crude hop extract.

Other hop and non-hop derived flavorants for use in the oil-in-water emulsions may include, but are not limited to, plant essential oils; botanical extracts (e.g., extracts from plants and plant materials), plant proteins, polysaccharides, starches, gums, oils, antioxidants, hydrocolloids, glucans; natural and artificial flavorants (e.g., substances added to impart aroma and/or flavor); natural and artificial flavor enhancers (e.g., substances added to supplement, enhance, or modify the original taste and/or aroma without imparting a characteristic taste or aroma of their own); natural and artificial flavoring agents and adjuvants (e.g., substances added to impart or help impart a taste or aroma in food); natural and artificial sweeteners-both nutritive and non-nutritive; natural and artificial antioxidants and their salts (e.g., butylated hydroxyanisole (BHA) and butylated hydroxytoluene (BHT), ferulic acid, caffeic acid, etc.); natural and artificial vitamins and their salts (e.g., vitamin c (ascorbic acid), sodium ascorbate, potassium ascorbate, vitamin e, vitamin b, vitamin k, etc.); natural and artificial nutrient supplements (e.g., substances necessary for the body's nutritional and metabolic processes, such as calcium, magnesium, potassium, etc.); antimicrobial agents (e.g., substances used to preserve food by preventing the growth of microorganisms and spoilage, including fungistats, mold inhibitors, and preservatives such as sorbic acid, and benzoate, suitable for use in consumable and topically applied substances); flavorants derived from or mimicking fruits, spices, herbs, flowers, and the like and combinations thereof, blends of plant-based and non-plant-based flavors (e.g., sweeteners, acids, salts, bittering agents, vitamins, minerals, proteins, hydrocolloids, carbohydrates, fats, oils, waxes, gums, and resins); celluloses and hemi-celluloses, other cellulosic materials, lignins, soluble and insoluble fiber, pectins, tannins, and particulate materials from plants; proteins, polysaccharides, sugars, starches, hydrocolloids, gums, oils, antioxidants, glucans, and acids: found in barley and oats; volatile and semi-volatile compounds from plants and plant materials: including terpenes, terpenoids, terpene blends, ketones, esters, aldehydes, alcohols, heterocycles and phenolics; thiols and polyfunctional thiols; compounds found in hops: resins, oils, waxes, tannins, proteins, pectins, cellulosic materials, alpha-acids, beta-acids, iso-alpha acids, isomerized and un-isomerized acids, rho iso-extract, tetra iso-extract, xanthohumol, polyphenols, and combinations thereof, and compounds found in cannabis (e.g., resins, oils, terpenes, waxes, tannins, proteins, pectins, cellulosic materials, cannabidiol (CBD), cannabidiolic acid (CBDA), tetrahydrocannabinol (THC), tetrahydrocannabinolic acid (THCA), cannabigerol (CBG), cannabichromene (CBC), cannabinol (CBN), cannabielsoin (CBE), iso-tetrahydrocannabinol (iso-THC), cannabicyclol (CBL), cannabicitran (CBT), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannflavin A, B or C, polyphenols, salts thereof, derivatives thereof, cannabis oil, cannabis extract and combinations thereof).

Examples of non-hop derived flavorants for use in the oil-in-water emulsions may include, without limitation, thiols or polythiols such as 3-mercaptohexan-1-ol (3MH), 3-mercaptohexyl acetate (3MHA), 3-mercaptohexyl butanoate (3MHB), 3-mercaptohexyl hexanoate (3MHH), 4-mercapto-4-methylpentan-2-one (4MMP), 3-sulfanyl-4-methylpentan-1-ol3 (S4MP) and 3-sulfanyl-4-methylpentyl acetate (3S4MPA); ketones such as methyl ethyl ketone, acetophenone, methyl 2-pyrollyl ketone, and 4-methyl acetophenone; esters such as ethyl butyrate, ethyl isovalerate, allyl caproate, methyl anthranillate, and ethyl acetoacetate; aldehydes such as vanillin, benzaldehyde, hexanal, heptanal, vetrialdehyde, cinnamaldehyde; alcohols such as hexanol, isoamyl alcohol, geraniol, butanol, and benzyl alcohol; heterocycles such as skatole, 4-acetoxy-2,5-dimethyl-3(2H)-furanone, methylthiophene, 2-acetylthiazole, 2-acetylpyridine, and 2,3,5,6-tetra methyl pyrazine; phenolics such as phenyl ethyl alcohol, and 4-methyl benzyl alcohol, ferulic acid; and the like and a combination of any two or more thereof. In some embodiments, the non-hop derived flavorant compound includes thiols, ketones, esters, aldehydes, heterocycles, alcohols, and phenolics, or a combination of any two or more thereof. In some embodiments, the non-hop derived flavorant compound includes 3-mercaptohexan-1-ol (3MH), 3-mercaptohexyl acetate (3MHA), 3-mercaptohexyl butanoate (3MHB), 3-mercaptohexyl hexanoate (3MHH), 4-mercapto-4-methylpentan-2-one (4MMP), 3-sulfanyl-4-methylpentan-1-ol3 (S4MP) and 3-sulfanyl-4-methylpentyl acetate (3S4MPA), methyl ethyl ketone, acetophenone, methyl 2-pyrollyl ketone, and 4-methyl acetophenone, ethyl butyrate, ethyl isovalerate, allyl caproate, methyl anthranillate, and ethyl acetoacetate, vanillin, benzaldehyde, hexanal, heptanal, vetrialdehyde, cinnamaldehyde, hexanol, isoamyl alcohol, geraniol, butanol, and benzyl alcohol, skatole, 4-acetoxy-2,5-dimethyl-3(2H)-furanone, methylthiophene, 2-acetylthiazole, 2-acetylpyridine, and 2,3,5,6-tetra methyl pyrazine, phenyl ethyl alcohol, and 4-methyl benzyl alcohol, ferulic acid; and the like and a combination of any two or more thereof.

In some embodiments, the flavorants may include an organosulfur compound. Suitable organosulfur compounds include, without limitation, prenyl mercaptan, 2-methylthiophene, 3-methylthiophene, diprenyl disulfide, 3-methyl-2-buten-1-yl thiolacetate, 3-methyl-1-[(3-methyl-2-buten-1-yl)sulfanyl]-2-butene, prenylmethylsulfide (1-(methylsulfanyl)-3-methyl-2-butene), prenyl thioacetate, thiogeraniol, 3-mercaptohexanol, 3-mercaptohexylacetate, 3-mercaptohexyl butyrate, 3-mercaptohexyl hexanoate, or a combination of any two or more thereof.

In some embodiments, the flavorant may include hop oil (e.g., hop essential oil, hop oil, full spectrum hop extract), hop extract (e.g., rho iso-extract, tetra iso-extract), hop acids (e.g., alpha-acids, beta-acids, iso-alpha acids, isomerized and un-isomerized acids), flavonoids (e.g., xanthohumol), polyphenols, carrier oils, flavorant blends, other hop derived compounds such as the salt forms of alpha-acids, beta-acids, polyphenols, etc., or non-hop derived flavorant compounds, or a combination of any two or more thereof.

Carrier oils may include common flavor carriers, which can improve the sweetness, texture, and shelf life of food and beverages. Suitable flavor carriers include, without limitation, sunflower seed oil, limonene—an organic carrier for organic molecules, triacetin—a viscous carrier commonly used for small volatiles, triethyl citrate—a viscous carrier commonly used for small volatiles, MCT, SCT, LCT (medium (6-12), short (<6), and long chain triglycerides (13-21)) oil-triglycerides that are used as carriers for other compounds, alpha-bisabolol—a sesquiterpenoid that has high solubility with organic compounds, elemene—a sesquiterpene carrier used for organic compounds, phytol—a diterpenoid carrier used for organic compounds, iso-phytol—a diterpenoid carrier used for organic compounds. Carrier oils, including flavor carriers can be a better alternative to petroleum-based additives because they have anti-bacterial properties and improve humectancy, can help with manufacturing safety and convenience, and can help control how and when flavor is released in a food product.

Addition of triglyceride oils was found to provide an additional, unexpected stability boost. Surprisingly, the inventors observed that incorporating a minor proportion of neutral triglyceride oils, such as for example, medium chain triglycerides (MCT) or sunflower seed oil at about 0.2 wt. % to about 3 wt. % of the total emulsion, or at an oil additive:flavorant ratio of about 2:1 in the oil phase, provided emulsions with even lower turbidity growth and tighter particle size distributions during accelerated storage.

In some embodiments, the flavorant may be cannabis or hemp based, including extracts of cannabis and hemp. In some embodiments, the flavorant may include cannabinoid compounds. In some embodiments, the flavorant may include a terpene compound, a cannabinoid active agent, and an organosulfur compound. In some embodiments, the flavorant includes bittering acids, and wherein the un-isomerized bittering acids are emulsified to increase water solubility. In some embodiments, the flavorant includes un-isomerized bittering acids, and wherein the un-isomerized bittering acids are emulsified to increase water solubility.

In some embodiments, the flavorant may include ‘flavor enhancers’ such as natural and artificial edible acids and their salts (e.g., food-grade acids and their salts); and fruit acids and their salts (e.g., tartaric acid, citric acid, malic acid, magnesium citrate, sodium citrate, potassium citrate, potassium bitartrate, potassium tartrate, sodium tartrate).

In some embodiments, the flavorant(s) may include, but are not limited to terpenes, terpenoids, terpenes, terpenoids, or blends of terpenes. The terpenes may include monoterpenes, sesquiterpenes, diterpenes, triterpenes, and the like, and combinations thereof. In some embodiments, the flavorant includes terpenes. Illustrative terpenes include, but are not limited to, α-bisabolol, borneol, camphene, camphor, β-caryophyllene, γ-3-carene, caryophyllene oxide, α-cedrene, β-eudesmol, fenchol, geraniol, guaiol, α-humulene, isoborneol, limonene, linalool, menthol, myrcene, nerol, cis-ocimene, trans-ocimene, α-phellandrene, α-pinene, β-pinene, sabinene, α-terpinene, α-terpineol, terpinolene, α-guaiene, elemene, farnesene, germacrene, guaiol, bergotamene, thujene, ylangene, sabinene hydrate, pinanol, selina-3,7(11)-diene, eudesm-7(11)-en-4-ol, valencene, and the like and combinations and blends thereof. In some embodiments, the flavorants include commercially available terpene blends.

In some embodiments, the emulsifying agent in the oil-in-water emulsion composition includes a phospholipid, potassium sorbate, sorbitan monooleate, sorbitan monolaurate, sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and medium and long chain triglycerides, and a combination of any two or more thereof. Suitable triglycerides include, for example, sunflower oil, MCT, oleic acid, linoleic acid, and the like, or a combination of any two or more thereof. In some embodiments, the emulsifying agent comprises a sunflower lecithin.

In some embodiments, the water is present in the oil-in-water emulsions in an amount corresponding to the remaining balance of material in the oil-in-water emulsion composition. In some embodiments, the oil-in-water emulsion composition is free of a weighting agent. In some embodiments, the oil-in-water emulsion composition is free of gum acacia. In some embodiments, the oil-in-water emulsion composition is free of polysorbates. In some embodiments, the oil-in-water emulsion composition is free of quillaja.

In some embodiments, the oil-in-water emulsion compositions exhibit reduction in particle size and/or particle size range, lower turbidity, pH stability, increased stability during storage and shelf life as compared to an otherwise identical formulated composition containing a weighting agent, gum acacia, or a mixture thereof. In some embodiments, the oil-in-water emulsion composition exhibits improved stability as compared to an identically formulated composition containing a weighting agent and/or gum acacia.

In at least some embodiments, the flavorant may be emulsified into a water-soluble liquid or water-soluble powder. In some embodiments, the flavorant may include exogenously added hop oil. In some embodiments, the flavorant may be infused into hop materials. Flavor carriers can improve the sweetness, texture, and shelf life of food and beverages. In other embodiments, the flavorant can be used as such and added directly to consumable products without being infused into hop materials. In some embodiments, The flavorant may be incorporated into a carrier system to provide a flavorant matrix. The flavorant matrix may then be exogenously added, emulsified and added or infused into a hop material and then added to the composition.

The one or more flavorants may constitute about 0.0001% to about 100% or 0.001% to about 50% by weight of the total weight of the emulsion composition. In some embodiments, the emulsion composition may include up to about 30% of the one or more flavorants by weight of the total emulsion composition, including up to about 20%, up to about 10%, up to about 5%, up to about 2%, up to about 1% or up to about 0.1% by weight of the total weight of the emulsion composition. In some embodiments, the emulsion composition may include at least about 0.0001% of flavorants by weight of the total weight of the emulsion composition, including at least about 0.001%, at least about 0.01%, at least about 0.05%, at least about 0.1%, at least about 0.5%, at least about 1% or at least about 2% by weight. In some embodiments, the emulsion composition may include about 0.0001% to about 30% of flavorants of the total weight of the composition, including without limitation, about 0.001% to about 20%, about 0.005% to about 15%, about 0.01% to about 10%, about 0.05% to about 8%, about 0.1% to about 5%, about 0.5% to about 5%, or about 1% to about 5% by weight of the total weight of the emulsion composition, or any range including and/or in-between any two of these values. In certain embodiments, the flavorant may be present in an amount of from about 0.001 wt. % to about 10 wt. %, based on the total weight of the emulsion composition. In some embodiments, the emulsion composition includes about 0.01% to about 30% of one or more flavorants of the total weight of the composition. In some embodiments, the emulsion composition includes about 0.05% to about 8% of one or more flavorants of the total weight of the composition.

The emulsion compositions may include an emulsifier adjuvant. Illustrative emulsifier adjuvants include but are not limited to, acids, salts, sugars, components of hop materials, and other emulsion formulation components. Suitable acids used as emulsifier adjuvants include, without limitation, citric acid, malic acid, tartaric acid, ascorbic acid, sorbic acid, caffeic acid, ferulic acid, and salts thereof, or combinations thereof. Suitable emulsifier adjuvants may include, but are not limited to chitosan, inulin, carrageenan, flaxseed mucilage, water soluble fraction of almond gum, maltodextrins, carbohydrates such as sugars (e.g., sucrose, glucose, fructose, trehalose, maltose, mannose; starches and modified starches (e.g., corn starch, rice starch, quinoa starch, mucunae bean starch (Mucuna Pruriens), oat beta glucans, barley beta glucans, pectin, low methoxyl pectin, pullulan, dextran, citric acid, tartaric acid, caffeic acid, ferulic acid, sodium citrate, potassium citrate, hop acids (e.g., alpha-acids, beta-acids, iso-alpha acids, isomerized and un-isomerized acids), rho iso-extract, tetra iso-extract, xanthohumol, Vitamin C (ascorbic acid), sodium ascorbate, potassium ascorbate, Vitamin E, Vitamin B, Vitamin K, and the like or a combination of any two or more thereof. Some emulsifier adjuvants can be multifunctional, possessing both stability to the emulsion system and acting as a flavor enhancer (e.g., citric acid and salts thereof). Such multifunctional emulsifier adjuvants” may include emulsion formulation components, such as sugars (e.g., monosaccharides, disaccharides, sugar alcohols).

In some embodiments, the emulsifier adjuvant for making the emulsions includes sugars such as monosaccharides, disaccharides and polysaccharides. In some embodiments, the emulsion composition may include one or more polyhydroxy disaccharides. Examples of polyhydroxy disaccharides may include, without limitation, lactose, maltose, sucrose, trehalose, dulcitol, glycerol, mannitol and sorbitol. Addition of such polyhydroxy disaccharides to the emulsions may provide a further, unexpected stabilization effect. For example, addition of a small amount of trehalose to the aqueous phase along with the phospholipid emulsifier was observed to provide emulsions with reduced turbidity growth and narrower particle size distributions over accelerated storage relative to otherwise identical formulations lacking trehalose. In some embodiments, the emulsion composition may include trehalose. In some embodiments, the emulsifier adjuvant includes sugars. In some embodiments, the emulsifier adjuvant includes trehalose.

The emulsifier adjuvants can be introduced separately in either the oil phase or the water phase prior to forming the emulsion. In some embodiments, the emulsifier adjuvants are included in the oil phase. In some embodiments, the emulsifier adjuvants are included in the water phase. In some embodiments, the emulsifier adjuvants are included in both the oil phase and the water phase. In some embodiments, the emulsifier adjuvants are simultaneously in both the oil phase and the water phase prior to forming the emulsion. Some of the non-limiting benefits associated with the use of an emulsifier adjuvant include, elimination of weighting agents, reduced turbidity, enhanced ease of emulsion formation, increased emulsion stability, decreased loss of flavor volatiles, and extended emulsion shelf-life.

In some embodiments, the emulsion compositions may include about 0.0001% to about 15% of the one or more emulsifier adjuvants by weight of the total weight of the emulsion composition. In some embodiments, the emulsion compositions include up to about 10% of emulsifier adjuvants by weight of the total emulsion composition, including up to about 8%, up to about 6%, up to about 5%, up to about 2%, up to about 1% or up to about 0.1% by weight of the total weight of the emulsion composition. In some embodiments, the emulsion compositions include at least about 0.0001% of emulsifier adjuvants by weight of the total weight of the emulsion composition, including at least about 0.001%, at least about 0.01%, at least about 0.05%, at least about 0.1%, at least about 0.5%, at least about 1% or at least about 2% by weight. In some embodiments, the emulsion compositions include about 0.0001% to about 15% of emulsifier adjuvants of the total weight of the composition, including without limitation, about 0.001% to about 12%, about 0.005% to about 10%, about 0.01% to about 8%, about 0.05% to about 6%, about 0.1% to about 5%, about 0.1% to about 3%, or about 0.1% to about 2% by weight of the total weight of the emulsion composition, or any range including and/or in-between any two of these values. In certain embodiments, the emulsifier adjuvant is present in an amount of from about 0.001 wt. % to about 15 wt. %, based on the total weight of the of the emulsion composition. In certain embodiments, the emulsifier adjuvant is present in an amount of from about 0.001 wt. % to about 10 wt. %, based on the total weight of the of the emulsion composition. In certain embodiments, the emulsifier adjuvant is present in an amount of from about 0.01 wt. % to about 5 wt. %, based on the total weight of the of the emulsion composition.

In some embodiments, the emulsion composition may include about 0.01% to about 10% of one or more sugars as the emulsifier adjuvants. In some embodiments, the emulsion composition may include about 0.01% to about 10% of a disaccharide (e.g., polyhydroxy disaccharide) as the emulsifier adjuvants. In some embodiments, the emulsion composition may include at least about 0.001% of one or more polyhydroxy disaccharides by weight of the total weight of the emulsion composition, including at least about 0.01%, at least about 0.05%, at least about 0.1%, at least about 0.2%, at least about 0.3% or at least about 0.5% by weight. In some embodiments, the emulsion composition may include about 0.01% to about 10% of one or more polyhydroxy disaccharides of the total weight of the emulsion composition, including without limitation, about 0.08% to about 8%, about 0.05% to about 5%, about 0.8% to about 3%, about 0.1% to about 1%, or about 0.3% to about 0.8% by weight of the total weight of the emulsion composition, or any range including and/or in-between any two of these values. In some embodiments, one or more polyhydroxy disaccharide includes trehalose. In some embodiments, the emulsion composition may include about 0.01% to about 10% of trehalose, based on the total weight of the emulsion composition, including without limitation, about 0.08% to about 8%, about 0.05% to about 5%, about 0.8% to about 3%, about 0.1% to about 1%, or about 0.3% to about 0.8% by weight of the total weight of the emulsion composition, or any range including and/or in-between any two of these values. In some embodiments, the emulsion composition may include about 0.01% to about 10% of trehalose as the emulsifier adjuvant.

The emulsion compositions may include one or more emulsifying agents with or without added emulsifier adjuvants. The emulsifying agents may be included in the water phase. Suitable emulsifying agents and emulsifier adjuvants include, but are not limited to, phospholipids (e.g., lecithin), potassium sorbate, sorbitan monooleate, sorbitan monolaurate (SPAN® 20), sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and the like and a combination of any two or more thereof. In some embodiments, the emulsifying agents include soy lecithin, sunflower lecithin, rapeseed lecithin, canola lecithin, safflower lecithin, and the like or combinations thereof. In some embodiments, the emulsifying agent includes a sunflower phospholipid (sunflower lecithin), e.g., from Perimondo under the brand names of Sunlipon®, including Sunlipon® 90, Sunlipon® 65, Sunlipon® 50, which are phospholipids containing at least about 60% phosphatidylcholine from sunflower lecithin. In some embodiments, the emulsifying agent includes a sunflower lecithin.

When included in the emulsion composition, either in the oil phase or the water phase or both, the emulsion compositions may include about 0.001% to about 20% of the one or more emulsifying agents by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the emulsifying agent is present in an amount of from about 0.001 wt. % to about 20 wt. %, based on the total weight of the of the emulsion composition. In some embodiments, the emulsifying agent is present in an amount of from about 0.01 wt. % to about 10 wt. %, based on the total weight of the of the emulsion composition.

In some embodiments, the oil-in-water emulsion compositions may include sunflower oil, medium chain triglycerides, trehalose, or sucrose, or any mixture of two or more thereof. In certain embodiments, the oil-in-water emulsion compositions include at least one of a sunflower lecithin, MCT, sunflower oil, and sugars (e.g., trehalose, sucrose).

The emulsion compositions may further include, either in the oil phase, the aqueous phase or both, additional additives that may provide additional benefits such as enhancements to texture, appearance, stability (chemical, physical, and microbiological stability), shelf-life and other functional benefits. Suitable additional additives include, but are not limited to, antimicrobial agents (e.g., substances used to preserve food by preventing the growth of microorganisms and subsequent spoilage, including fungistats, mold and rope inhibitors, and other effects listed by the national academy of sciences/national research council under “preservatives”); antioxidants (e.g., substances used to preserve food by retarding deterioration, rancidity, or discoloration due to oxidation); colors and coloring adjuncts (e.g., substances used to impart, preserve, or enhance the color or shading of food, including color stabilizers, color fixatives, and color-retention agents); curing and pickling agents (e.g., substances that impart a unique flavor and/or color to food, usually increasing shelf life stability); drying agents (e.g., substances with moisture-absorbing abilities, used to maintain an environment of low moisture); enzymes (e.g., enzymes used to improve food processing and the quality of the finished food); firming agents (e.g., substances added to precipitate residual pectin, strengthening the supporting tissue and preventing collapse during processing); flour treating agents (e.g., substances added to milled flour to improve its color and/or baking qualities, including bleaching and maturing agents); formulation aids (e.g., substances used to promote or produce a desired physical state or texture in food, including carriers, binders, fillers, plasticizers, film-formers, and tableting aids); humectants (e.g., hygroscopic substances incorporated in food to promote moisture retention, including moisture-retention agents and antidusting agents); leavening agents (e.g., substances used to produce or stimulate the production of carbon dioxide in baked goods to impart a light texture, including yeast, yeast foods, and calcium salts listed under “dough conditioners”); nutrient supplements (e.g., substances necessary for the body's nutritional and metabolic processes); oxidizing and reducing agents (e.g., substances that chemically oxidize or reduce another food ingredient, thereby producing a more stable product, including effects listed under “dough conditioners”); pH control agents (e.g., substances added to change or maintain active acidity or basicity, including buffers, acids, alkalis, and neutralizing agents); processing aids (e.g., substances used as manufacturing aids to enhance the appeal or utility of a food or food component, including clarifying agents, clouding agents, catalysts, flocculants, filter aids, and crystallization inhibitors); sequestrants (e.g., substances that combine with polyvalent metal ions to form a soluble metal complex, improving the quality and stability of products); solvents, carriers and vehicles (e.g., substances used to extract or dissolve another substance); stabilizers and thickeners (e.g., substances used to produce viscous solutions or dispersions, to impart body, improve consistency, or stabilize emulsions, including suspending agents, bodying agents, setting agents, jellying agents, and bulking agents); surface-active agents (e.g., substances used to modify surface properties of liquid food components for various effects, including solubilizing agents, dispersants, detergents, wetting agents, rehydration enhancers, whipping agents, foaming agents, and defoaming agents); synergists (e.g., substances that react with another food ingredient to produce an effect different or greater than the sum of the effects produced by the individual ingredients); texturizers (e.g., substances that affect the appearance or feel of the food); acids, including inorganic and organic acids and their salts (e.g., citric acid, tartaric acid, malic acid, folic acid, fumaric acid, lactic acid, acetic acid, phosphoric acid, ascorbic acid); salts including hydroxides, carbonates, bicarbonates, chlorides, gluconates, acetates, sulfides and sulfides of sodium, potassium, calcium, magnesium, and the like (e.g., chlorides, such as sodium chloride, potassium chloride, and magnesium chloride; carbonate salts, such as sodium carbonate, potassium carbonate, and calcium carbonate; bicarbonate salts, such as sodium bicarbonate; phosphate salts, such as disodium hydrogen phosphate, trisodium phosphate, dipotassium hydrogen phosphate, and tripotassium phosphate; sodium polyphosphate; citrate salts, such as sodium citrate; hydroxides such as sodium hydroxide, potassium hydroxide, magnesium hydroxide; acetates such as sodium acetate, potassium acetate; lactates such as sodium lactate, calcium lactate, magnesium lactate); and the like, or combinations thereof. Depending upon the end application, the compositions may include other ingredients, such as surfactants, co-solvents, propellants, other flavoring agents, medicinal agents, perfumes, stabilizers, thickeners, binders, preservatives, emulsifiers, essential oils, water, sweeteners, gelatin, food additives, colorants, carriers, excipients, diluents, and the like or a combination of any two or more thereof.

When included, the emulsion compositions may include about 0.001% to about 20% of the one or more additional additives by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the additional additives is present in an amount of from about 0.001 wt. % to about 10 wt. %, based on the total weight of the of the emulsion composition.

In one aspect, the present technology provides a composition in the form of an oil-in water emulsion comprising: an oil phase comprising about 0.01 wt. % to about 10 wt. % of flavorant; and optionally about 0.01 wt. % to about 10 wt. % of emulsifier adjuvant; and a continuous aqueous phase comprising water and about 0.01 wt. % to about 10 wt. % of an emulsifying agent, wherein all weight percentages are based on the total weight of the composition. In some embodiments, the composition is substantially free of weighting agents and/or gum acacia. In some embodiments, the composition is substantially free of gum acacia. In some embodiments, the composition is substantially free of ester gum. In some embodiments, the composition is substantially free of brominated vegetable oil. In some embodiments, the flavorant includes terpenes. In some embodiments, the emulsifying agent includes a sunflower phospholipid. In some embodiments, the emulsifier adjuvant includes citric acid or a salt thereof.

In one aspect, the present technology provides a composition in the form of an oil-in water emulsion which includes about 0.01 wt. % to about 8 wt. % of flavorant, about 0.01 wt. % to about 5 wt. % of a sunflower lecithin, 0.01 wt. % to 0.1 wt. % of citric acid, and water in an amount corresponding to the remaining balance of material in the oil-in-water emulsion composition, wherein all weight percentages are based on the total weight of the composition, and wherein the oil-in-water emulsion composition is substantially free of a weighting agent and/or gum acacia. The oil-in-water emulsion composition exhibits improved stability as compared to an otherwise identical formulated composition but containing a weighting agent and/or gum acacia.

The emulsion compositions described herein have several advantages. For example, the emulsion compositions may exhibit improved stability as compared to an identically formulated composition containing a weighting agent and/or gum acacia. Improved stability may include short-term stability, long-term stability, or both. For example, improved stability, in some embodiments, may include improved initial stability, e.g., particle size of the initial solution.

The emulsion compositions described herein may be used in a variety of products including edible products, aerosol products, fragrance products, flavor products, pharmaceutical product, inhalable products, consumer products. According to one aspect, provided is a product which includes the oil-in-water emulsion compositions. In some embodiments, the product is an edible product, a flavor product, or a fragrance product. In some embodiments, the edible product is a food or beverage product. In some embodiments, the beverage is beer, an alcohol containing beverage, or a non-alcohol containing beverage product. In some embodiments, the beverage product is a fermented beverage. In some embodiments, the fermented beverage may be kombucha, beer, wine, or cider.

The compositions may synergistically enhance the olfactory effects of products to which they are added. In certain embodiments, the compositions can be used as an additive to synergistically enhance the aroma and/or flavor of products such as edible products, fragrance products, flavor products, and other consumer products. In certain embodiments, the edible product is a food product or a beverage product. In some embodiments, the beverage is a carbonated beverage.

The emulsion compositions described herein may be used in a wide variety of products including, but not limited to, baked goods and baking mixes (e.g., breads, rolls, brownies, cookies, and snacks, ready-to-eat and ready-to-bake products, flours, and mixes requiring preparation); gummies, jams, jellies, candy, beverages (e.g., alcoholic and non-alcoholic drinks, including cocktails, mocktails, liquors, beers, wines, ciders, fruit drinks, lemonades, coffees, and teas); alcoholic beverages (e.g., malt beverages, wines, distilled liquors, and cocktail mixes), nonalcoholic beverages (e.g., special or spiced teas, soft drinks, coffee substitutes, and fruit and vegetable flavored gelatin drinks); protein drinks (e.g., dairy-based, soy-based, almond-based, oat-based, rice-based, and other grain or nut-based drinks); breakfast cereals (e.g., ready-to-eat, instant, and regular hot cereals); cheeses (e.g., curd and whey cheeses, cream, natural, grating, processed, spread, dip, and miscellaneous cheeses; confectionaries (e.g., chewing gum; gummies, candy, hard and soft candy, candy bars, chocolates, fudge, mints, and other chewy candies); coffee and tea (e.g., regular, decaffeinated, and instant types); condiments and relishes (e.g., plain seasoning sauces and spreads, olives, pickles, and relishes); confections and frostings (e.g., flavored frostings, marshmallows, baking chocolate, and various sugars); dairy product analogs and dairy based drinks (e.g., nondairy milk, creamers, coffee whiteners, toppings, and other nondairy products); egg products (e.g., liquid, frozen, or dried eggs); fats and oils (e.g., margarine, dressings, butter, salad oils, shortenings, and cooking oils); fish products (e.g., prepared main dishes, salads, appetizers, frozen meals, and spreads containing fish); fresh eggs (e.g., cooked eggs and dishes made from fresh shell eggs); fresh fish (e.g., fresh and frozen fish, shellfish, and other aquatic animals); fresh fruits and fruit juices (e.g., raw fruits, citrus, melons, berries, and home-prepared punches); fresh meat and meat products (e.g., fresh or home-frozen beef, veal, pork, lamb, or mutton, meat-containing dishes, salads, appetizers, frozen meals, and deli meat); fresh poultry and poultry products (e.g., fresh or home-frozen poultry and game birds, poultry and poultry-containing dishes, salads, appetizers, frozen meals, and sandwich ingredients); fresh vegetables (e.g., tomatoes, and potatoes, fresh and home-prepared vegetables); frozen dairy desserts and mixes (e.g., ice cream, ice milks, sherbets, and other frozen dairy desserts); fruit and water ices; gelatins, puddings, and fillings (e.g., flavored gelatin desserts, puddings, custards, parfaits, pie fillings, and gelatin base salads); grain products and pastas (e.g., macaroni and noodle products, rice dishes, and frozen multicourse meals); gravies and sauces (e.g., meat sauces, gravies, and various specialty sauces); hard candy and cough drops; herbs, seeds, spices, seasonings, blends, extracts, and flavorings; jams and jellies (e.g., home-prepared and commercially processed jams, jellies, fruit butters, preserves, and sweet spreads); milk and milk products (e.g., whole, low-fat, skim fluid milks, flavored milks, dry milks, toppings, snack dips, spreads, weight control milk beverages, and other milk origin products); nuts and nut products (e.g., whole or shelled tree nuts, peanuts, coconut, and nut spreads); plant protein products (e.g., meat, poultry, and fish substitutes, analogs, and extender products made from plant proteins); processed fruits and fruit juices (e.g., commercially processed fruits, salads, juices, punches, concentrates, and drink substitutes); processed vegetables and vegetable juices (e.g., commercially processed vegetables, dishes, frozen meals, and vegetable juices); snack foods (e.g., chips, pretzels, and other novelty snacks); soups and soup mixes (e.g., home-prepared and commercially made meat, fish, poultry, vegetable, and combination soups; white granulated sugar; granulated, liquid, and tablet sugar substitutes; sauces (both sweet and savory; e.g., marinades, dressings, cheese-based sauces) toppings, and syrups (e.g., chocolate, caramel, berry, fruit, corn syrup, and maple sweet sauces and toppings); These potential applications, illustrate the versatility and wide-reaching impact of the emulsion compositions provided in the disclosure.

In another aspect, the present technology relates to various products that may include the emulsion compositions described herein. Illustrative products include, without limitation, edible products, fragrance products, and flavor products. In certain embodiments, an edible product comprising an emulsion composition described herein is provided. In certain embodiments, the edible product is a food or beverage product. In certain embodiments, the beverage is a fermented beverage including but not limited to kombucha, beer, wine, cider. In certain embodiments, the beverage is beer, any alcohol containing beverage, or other non-alcohol beverage product. In certain embodiments, a flavor and fragrance product comprising the emulsion composition described herein is provided. In certain embodiments, an inhalable product comprising the emulsion composition described herein is provided. In certain embodiments, the inhalable product is a vaping composition. In certain embodiments, a flavor and/or fragrance delivery system comprising the emulsion composition described herein is provided.

In some embodiments, the present technology relates to beverage products that may include the emulsion compositions described herein. Traditional compositions and emulsification methods for preparation of oil-in-water emulsions suitable for use in beverage products rely on the use of gum acacia and weighting agents (e.g., ester gum, brominated vegetable oil, etc.) to achieve aroma and/or flavor enhancements in a stable emulsion. The present technology advantageously provides compositions and methods which eliminate the use of gum acacia and weighting agents.

The emulsion compositions may be included in the products in an amount suitable to provide the desired stability or other property of the product, ranging from about 0.0001% to 50% by weight or volume, including from about 0.001% to 30%, about 0.05% to 20%, about 0.01% to 10%, about 0.01% to 5%, or about 0.01% to 3%, of the total weight or volume of the product, or any range including and/or in-between any two of these values For example, when used in a beverage, the emulsion compositions may be included in a concentration range of from about 0.01% to 10%, or about 0.05% to 8%, or about 0.1% to 5%, or about 0.5% to 3%, by volume, depending on the specific beverage formulation.

In one aspect, the present technology relates to methods for preparing an oil-in-water emulsion or a multi-layered oil-in-water emulsion. In another aspect, the present technology relates to methods for forming stable oil-in-water emulsions. The methods include, for example: (i) providing an oil phase comprising flavorants and optionally an emulsifier adjuvant; (ii) providing an aqueous phase comprising water and an emulsifying agent and optionally emulsifier adjuvant; (iii) mixing said oil phase and said aqueous phase so as to obtain a pre-emulsion; and (iv) homogenizing the pre-emulsion to obtain said oil-in-water emulsion; wherein the emulsion is substantially free of weighting agents and/or gum acacia. In some embodiments, the homogenizing includes a multi-stage homogenization process.

According to another aspect, provided is a method comprising: (i) providing an oil phase comprising a flavorant; (ii) providing an aqueous phase comprising water, one or more emulsifying agents, and one or more emulsifier adjuvants; (iii) mixing the oil phase and the aqueous phase to obtain a pre-emulsion; and (iv) homogenizing the pre-emulsion to obtain an oil-in-water emulsion; wherein the oil-in-water emulsion is substantially free of weighting agents and/or gum acacia. In some embodiments, the homogenizing includes a multi-stage homogenization process.

In some embodiments, the aqueous phase is the continuous phase. The aqueous phase is prepared by mixing the appropriate amount of emulsifying agents (e.g., soy lecithin), emulsifier adjuvants (e.g., potassium sorbate) and optionally additional additives (e.g., citric acid or sodium citrate, potassium citrate, potassium ascorbate, sodium ascorbate) with water, until the ingredients dissolve in water. The temperature of the aqueous phase is monitored to ensure it does not rise above desired levels, and the pH is checked using a pH meter and adjusted if necessary to optimize for stability and preservation. The oil phase may be prepared by mixing the flavorants (e.g., terpenes) optionally with the emulsifier adjuvants. In some embodiments, the oil phase is slowly added while controlling the rate of addition to prevent any sudden phase separation, to form a pre-emulsion. After the oil phase has been added, the pre-emulsion is sheared at high speed (e.g., 5000 RPM) for a suitable period of time to ensure thorough emulsification and uniform consistency. The mixture is inspected to confirm even distribution of the oil droplets in the water phase. The solution is allowed to sit for a suitable time period to let any excess air bubbles escape, improving the overall stability of the pre-emulsion. De-aeration can also be assisted by a vacuum chamber or desiccator if needed. The pre-emulsion is slowly fed into the homogenizer at a suitable pressure and temperature and processed times to achieve optimal particle size reduction. This step can be conducted in an inert atmosphere. In some embodiments, the homogenizing comprises a multi-stage homogenization process. For example, in some embodiments, the homogenization is performed in two stages—in the first stage, the homogenizer I set at a high pressure (e.g., 10000-12000 psi) and the pre-emulsion is processed. In the second stage, the homogenized pre-emulsion is processed in a homogenizer which is maintained at a lower pressure, e.g., at 20% of the first stage pressure (e.g., 2000-2400 psi). The temperature at first and second homogenization stage is maintained at or below about 40° C. An optional step is to purge the resulting solution with inert gas to minimize oxygen ingress.

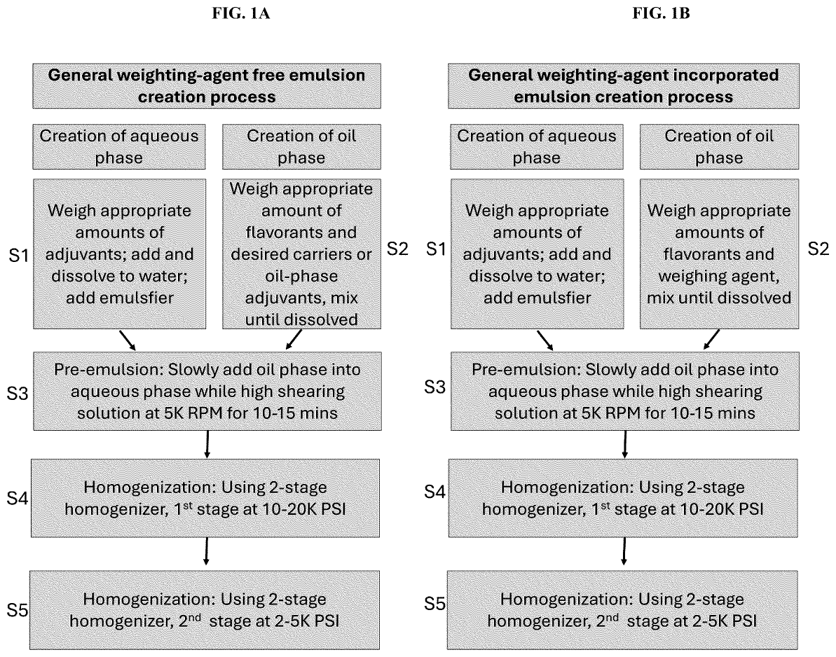

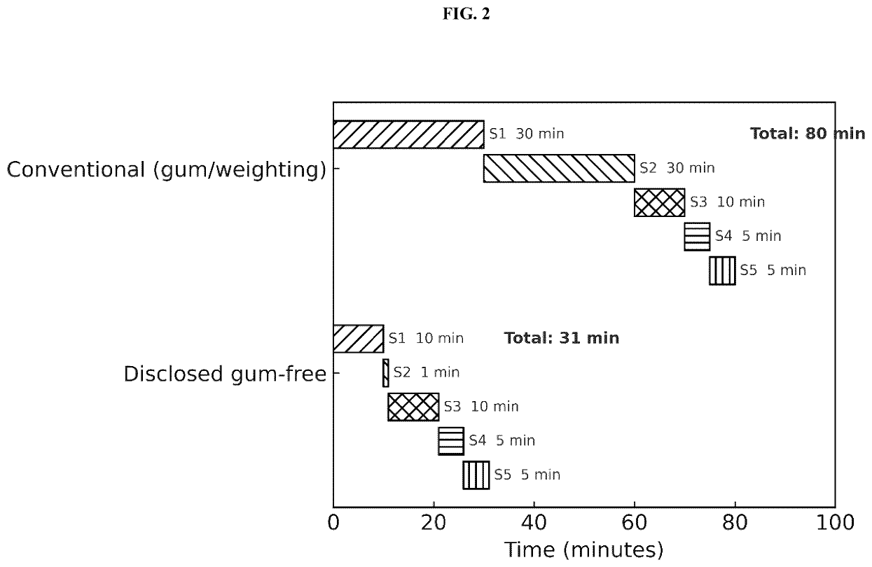

FIG. 1A shows a schematic representation of a method of preparation of the oil-in-water emulsion composition for an emulsion not containing gum acacia and not containing weighting agent (e.g., gum acacia free and ester gum free emulsion). FIG. 1B shows a schematic representation of a method of preparation of the oil-in-water emulsion composition containing gum acacia and/or weighting agent (e.g., the emulsion is made using gum acacia and ester gum). An analysis of process time reveals increased throughput by way of minimizing the dissolution of gums or other ingredients, as illustrated in the Gantt chart in FIG. 2. These further highlight the benefits of the methods and compositions of the present technology.

The emulsion samples prepared according to the described methods are collected and tested for parameters like particle size, stability, and consistency. The results demonstrated that the present technology provided stable flavorant emulsions without the need for conventional weighting agents or extended processing times.

In another aspect, the present technology relates to methods for stabilizing oil-in-water emulsions, wherein the method includes adding to the emulsion composition about 0.01% to about 30% by weight based on the total weight of the emulsion of a sunflower phospholipid. In some embodiments, the method further includes incorporating adding about 0.01% to about 30% by weight based on the total weight of an emulsifier adjuvants to control the pH of the emulsion composition.

In another aspect, the present technology relates to methods for preparing a natural preservative and stabilizer for food and beverages. In yet another aspect, the present technology relates to methods for preserving food and beverages. The methods includes forming and stabilizing emulsion compositions for use in food and beverages by using natural preservative agents, wherein the emulsion compositions includes a plant-derived flavorant additive, salts, acids, and emulsifier adjuvants.

In one aspect, the present technology relates to methods for using the oil-in-water emulsions or multi-layered oil-in-water emulsions. The methods include, for example, plating the emulsion onto either wet or dry surfaces in the form of layers or films. Such films or edible layers may be used as final products or may undergo further treatment and/or processing as needed to form an edible layer or film that can be consumed or incorporated into a food product. In another embodiment, the methods include, for example, plating the emulsion onto either wet or dry particles Such particles may be used as final products or may undergo further treatment and/or processing as needed to form edible particles that can be consumed or incorporated into a food or beverage product, or that can be dissolved and/or dispersed in a consumable liquid. Further treatment or processing may include step such as e.g., drying, coating with another layer, agglomeration, encapsulation, mixing, blending, size classification, size reduction, milling, spherification, preservation, and the like and combinations of any two or more thereof.

According to one aspect, provided is a method comprising plating the oil-in-water emulsion compositions of the present technology onto wet or dry surfaces of an edible layer or film; and processing the edible layer or film to provide consumable product. In another aspect, provided is a method comprising plating the oil-in-water emulsion compositions of the present technology onto wet or dry particles; and processing the dry particles to provide consumable product. According to yet another aspect, provided is a method comprising plating the oil-in-water emulsion composition of the present technology onto wet or dry surfaces of an edible film or layer, or onto wet or dry particles; treating and drying the film, layer or particles, and processing the dry particles or film to provide consumable product. In some embodiments, the treating step may include coating with another layer, agglomeration, encapsulation, drying, or a combination of any two or more thereof, e.g., layer coating and drying, agglomeration and drying, encapsulation and drying, layer coating, agglomeration and drying, etc. The consumable product may include the food or beverage products, including fermented beverages such as kombucha, beer, wine, or cider.

The present technology is associated with advantages such as elimination of weighting agents, reduced processing times, enhanced regulatory compliance, lower production costs, preservation of flavor and aroma, providing clear beverage emulsions and increasing the emulsion stability and shelf-life. The present technology provides a formulation process that does not require weighting agents, thus reducing turbidity, and simplifying the emulsion creation, and streamlines the emulsification process by eliminating the need for lengthy hydration steps, thereby shortening the overall production time. The compositions and methods described herein allow quick, consistent, and easy incorporation of aroma and/or flavor enhancement into products. Additionally, the use of ingredients like BVO and gum acacia is avoided thereby ensuring compliance with regulatory standards and enhancing the safety profile of the emulsions, and the ingredient and processing costs are reduced by eliminating expensive and scarce components, making the production of flavorant emulsions more economical. The present technology further improves the retention of volatile flavor and aroma compounds during emulsification, resulting in superior sensory quality of the final product. Finally, the present technology enhances the stability and shelf-life of the emulsion compositions without the need for traditional stabilizers, ensuring consistent performance over time and creates stable oil-in-water emulsions that maintain clarity in beverages, enhancing visual appeal and product quality. The oil-in-water emulsions of the present technology exhibit a minimum fall in pH, turbidity, and particle size distribution (d50) over short and long term storage. In some embodiments, the oil-in-water emulsion compositions of the present technology exhibit improved stability as compared to a composition containing a weighting agent and/or gum acacia. In some embodiments, the oil-in-water emulsion compositions of the present technology exhibit improved stability as compared to an identically formulated composition containing a weighting agent and/or gum acacia. In some embodiments, the oil-in-water emulsion compositions of the present technology exhibit a stable particle size distribution on storage as compared to an identically formulated composition containing a weighting agent and/or gum acacia. In some embodiments, the oil-in-water emulsion compositions of the present technology exhibit a stable pH on storage as compared to an identically formulated composition containing a weighting agent and/or gum acacia. In some embodiments, the oil-in-water emulsion compositions of the present technology exhibit a stable or reduced turbidity on storage as compared to an identically formulated composition containing a weighting agent and/or gum acacia.

The present invention, thus generally described, will be understood more readily by reference to the following examples, which are provided by way of illustration and are not intended to be limiting of the present invention.

### EXAMPLES

Various embodiments will be further clarified by the following examples, which are in no way intended to limit this disclosure thereto. All amounts are in wt. %, based in the total weight of the emulsion composition, unless otherwise specified.

### Example 1: Preparation of Weighting Agent-Free Emulsion Formulation with Sunflower Lecithin

Preparation of Oil Phase: Suitable amounts (e.g., 2-20%) of oil-soluble terpenes are measured.

Preparation of Water Phase: Potassium sorbate (e.g., 0.1%), citric acid (e.g., 0.08%) and distilled water are sequentially added into a clean beaker. The solution is stirred continuously using a Silverson L5M-A mixer at low RPM to ensure full dissolution of the potassium sorbate. Suitable amount (e.g., 1%), of Sunflower lecithin (Sunlipon® 65, phospholipids containing at least about 60% phosphatidylcholine from sunflower lecithin, Perimondo, New York, N.Y) is gradually added to the water phase. The resulting solution is mixed for 10-15 min using a Silverson L5M-A mixer with a general mixing head, at a speed set to 5000 RPM. The mixing is done to ensure that the emulsifier fully dissolves, and the temperature is monitored throughout the process to ensure it does not rise above desired levels. The solution is allowed to return to room temperature naturally once mixing is complete. After dissolution is completed, the pH is checked using a pH meter and adjusted if necessary to optimize for stability and preservation.

Preparation of Pre-emulsion Solution: The oil phase is slowly added to the prepared water phase while controlling the rate of addition to facilitate emulsion formation. After the oil phase has been added, the Silverson L5M-A mixer is switched to the emulsifying head and the speed is increased to 5000 RPM. The mixture is mixed for 10 min to ensure thorough emulsification and uniform consistency. The mixture is inspected to confirm even distribution of the oil droplets in the water phase. The solution is allowed to sit for 30 min to let any excess air bubbles escape, improving the overall stability of the pre-emulsion. De-aeration can also be assisted by a vacuum chamber or desiccator if needed. This process can be done in an inert atmosphere to minimize oxygen. Alternatively or additionally, the resulting solution can be purged to remove dissolved oxygen. In another option, an inert gas blanket can be applied to minimize oxygen incorporation.

Homogenization: Before starting the homogenization process, the cooling water system and digital pressure gauge are activated to maintain temperature control and monitor homogenization pressures. 200-500 mL of distilled water is added to the feed hopper to adjust the homogenizer parameters before processing the main batch. 500 mL of the pre-emulsion is added into the feed hopper, following which the homogenizer is started and the pressure is adjusted to 10000-12000 psi for the first stage. The second-stage pressure is set to 20% of the first stage pressure (approximately 2000-2400 psi). Both the pressure and temperature are carefully monitored during this process to ensure the system operates within safe limits, as well as monitoring emulsion temperature to ensure minimal off gassing. The pre-emulsion is slowly fed into the homogenizer and processed twice to achieve optimal particle size reduction. The feed hopper is monitored to ensure it does not empty, thereby preventing cavitation. The temperature increases are monitored, ensuring they remain within a 5-10° C. rise per pass to maintain emulsion integrity. If necessary, external cooling methods are used to keep the temperature within range. The samples are collected during the second homogenization run for performing quality control testing which includes parameters like particle size, zeta potential, pH, particle size range, turbidity, acidity and consistency. Once complete, the homogenizer pressure is disengaged by turning the hand wheels counterclockwise, bringing the pressure to zero safely.

### Example 2: Preparation of Comparative Emulsion Formulation with Ester Gum and Citric Acid

Preparation of Oil Phase: Suitable amount of ester gum (e.g., 1-6%) is measured and added directly to an oil-soluble flavorant (e.g., terpene) blend mixture in a beaker. The mixture is stirred thoroughly until the ester gum is fully dissolved. No heat is added to ensure minimal loss of volatiles. The beaker sides and the mixing head are periodically scraped as necessary to prevent any material from sticking, which could cause uneven mixing or injury from buildup. The ester gum helps adjust the density of the oil/flavorant mixture, ensuring better compatibility with the water phase, and improves the stability of the final emulsion by reducing density differences between the oil and water phases.

Preparation of Water Phase: Suitable amount of citric acid (e.g., 0.03%) and distilled water are sequentially added into a clean beaker. The solution is stirred continuously using a Silverson L5M-A mixer at low RPM to ensure full dissolution of the citric acid. Once the citric acid is fully dissolved, the solution is allowed to return to room temperature. The pH of the solution is measured using a calibrated pH meter, and adjusted as necessary to optimize stability. Citric acid will lower the pH of the emulsion, which is useful for preservative action and emulsion stability.

Preparation of Pre-emulsion Solution: The prepared oil phase containing terpenes and ester gum is slowly added to the water phase. The rate of addition is controlled to prevent sudden separation. The ester gum, having adjusted the density of the oil/terpene mixture, allows for smoother integration into the water phase, minimizing the risk of phase separation during mixing. After the oil phase has been added, the Silverson L5M-A mixer is switched to the emulsifying head and the speed is increased to 5,000 RPM. The mixture is mixed for 10 min to ensure thorough emulsification and uniform consistency. The mixture is inspected to confirm even distribution of the oil droplets in the water phase. The solution is allowed to sit for 30 min to allow any trapped air bubbles to escape, improving the stability of the final pre-emulsion. If necessary, a vacuum chamber can be used to assist with de-aeration.

Homogenization: An APV 1,000/2,000 homogenizer is prepared by activating the cooling water system and digital pressure gauge. 200-500 mL of distilled water is added to the feed hopper to adjust the homogenizer parameters before processing the main batch. With 500 mL of the pre-emulsion in the feed hopper, the homogenizer is started and the pressure is adjusted to 10,000-12,000 psi for the first stage. The second-stage pressure is set to 20% of the first-stage pressure (about 2,000-2,400 psi) and temperature increases are monitored, ensuring they remain within a 5-10° C. rise per pass. The pre-emulsion is slowly fed into the homogenizer and processed twice to achieve optimal particle size reduction. The feed hopper is monitored to ensure it does not empty, thereby preventing cavitation. The samples are collected during the second run for performing quality control testing which includes parameters like particle size and stability. Once complete, the homogenizer pressure is disengaged by turning the hand wheels counterclockwise, bringing the pressure to zero safely.

### Example 3: Preparation of Weighting Agent-Free Emulsion Formulation with Sunflower Lecithin with Oil-Phase Oil Adjuvant

Preparation of Oil Phase: The oil phase was prepared by measuring appropriate quantities (e.g., 2-10%) of oil-soluble flavorants (e.g., terpenes) and combining them with a single co-emulsifier, e.g., sunflower seed oil, triacetin (glycerol triacetate), triethyl citrate, or MCT oil, at a 2:1 terpene:co-emulsifier ratio, followed by mixing the solution until it is homogeneous.

Preparation of Water Phase: Suitable amounts of potassium citrate (e.g., 0.07%), citric acid (e.g., 0.03%), ascorbic acid (e.g., 0.02%), trehalose (e.g., 5%), and distilled water were added sequentially to a clean beaker and stirred with a Silverson L5M-A at low rpm until complete dissolution. Sunflower lecithin (Sunlipon® 65; ≥60% phosphatidylcholine; Perimondo, New York, NY) was then introduced gradually, and mixing was continued with the general mixing head at 5000 rpm for 10-15 min to ensure full dissolution of the emulsifier. Temperature was monitored to avoid excessive heating, the solution was allowed to return to ambient temperature, and the pH was measured and adjusted as necessary to optimize stability and preservation.

Preparation of Pre-emulsion Solution: The pre-emulsion was formed by adding the oil phase slowly to the aqueous phase at a controlled rate to promote droplet formation. The mixer was fitted with the emulsifying head and operated at 5000 rpm for 10 min to achieve a uniform dispersion, which was inspected for even droplet distribution. The mixture was then allowed to stand for approximately 30 min to release entrained air; where necessary, de-aeration was assisted under vacuum (vacuum chamber or desiccator). Oxygen exposure was minimized by conducting the procedure under an inert atmosphere, purging to remove dissolved oxygen, and/or applying an inert gas blanket.

Homogenization: Before high-pressure homogenization, the cooling-water system and digital pressure gauge were activated. To set operating parameters, 200-500 mL of distilled water was added to the feed hopper, followed by 500 mL of pre-emulsion. The homogenizer was operated with a first-stage pressure of 10,000-12,000 psi and a second-stage pressure equal to ˜20% of the first stage (≈2,000-2,400 psi). The pre-emulsion was processed through two passes at a controlled feed rate, while preventing the hopper from running dry to avoid cavitation. Pressure and temperature were monitored continuously, and temperature rise was limited to 5-10° C. per pass through external cooling as needed to preserve emulsion integrity and minimize off-gassing. Samples collected during the second pass were subjected to quality-control measurements, including particle size and distribution, zeta potential, pH, turbidity, acidity, and batch-to-batch consistency. Upon completion, system pressure was released by turning the hand wheels counterclockwise to return the instrument to zero.

### Example 4: Preparation of Weighting Agent-Free Emulsion Formulation with Sunflower Lecithin with Oil-Phase Oil Adjuvant and Sugar-Based Adjuvant

Preparation of Oil Phase: The oil phase was prepared by measuring appropriate quantities of oil-soluble terpenes (e.g., 2-5%) and combining them with a co-emulsifier, e.g., sunflower seed oil, triacetin (glycerol triacetate), triethyl citrate, or MCT oil, at a 2:1 terpene co-emulsifier ratio, followed by mixing until homogeneous.

Preparation of Water Phase: Suitable amounts of potassium citrate (e.g., 0.07%), citric acid (e.g., 0.03%), ascorbic acid (e.g., 0.02%), trehalose (e.g., 5%), and distilled water were sequentially added to a clean beaker and stirred with a Silverson L5M-A at low rpm until complete dissolution. Sunflower lecithin (Sunlipon® 65; ≥60% phosphatidylcholine; Perimondo, New York, NY) was then introduced gradually, and mixing was continued with the general mixing head at 5000 rpm for 10-15 min to ensure full dissolution of the emulsifier. Temperature was monitored to avoid excessive heating, the solution was allowed to return to ambient temperature, and the pH was measured and adjusted as necessary to optimize stability and preservation.

Preparation of Pre-emulsion Solution: The pre-emulsion was formed by adding the oil phase slowly to the aqueous phase at a controlled rate to promote droplet formation. The mixer was fitted with the emulsifying head and operated at 5000 rpm for 10 min to achieve a uniform dispersion, which was inspected for even droplet distribution. The mixture was then allowed to stand for approximately 30 min to release entrained air; where necessary, de-aeration was assisted under vacuum (vacuum chamber or desiccator). Oxygen exposure was minimized by conducting the procedure under an inert atmosphere, purging to remove dissolved oxygen, and/or applying an inert gas blanket.

Homogenization: Before high-pressure homogenization, the cooling-water system and digital pressure gauge were activated. To set operating parameters, 200-500 mL of distilled water was added to the feed hopper, followed by 500 mL of pre-emulsion. The homogenizer was operated with a first-stage pressure of 10,000-12,000 psi and a second-stage pressure equal to ˜20% of the first stage (≈2,000-2,400 psi). The pre-emulsion was processed through two passes at a controlled feed rate, while preventing the hopper from running dry to avoid cavitation. Pressure and temperature were monitored continuously, and temperature rise was limited to 5-10° C. per pass through external cooling as needed to preserve emulsion integrity and minimize off-gassing. Samples collected during the second pass were subjected to quality-control measurements, including particle size and distribution, zeta potential, pH, turbidity, acidity, and batch-to-batch consistency. Upon completion, system pressure was released by turning the hand wheels counterclockwise to return the instrument to zero.

### Example 5: Oil-In-Water Emulsion without Ester Gum and without Gum Acacia with Different Flavorants

Weighting agent-free oil-in-water emulsion compositions were prepared using the method described in Example 1 and a control/comparative emulsion formulation containing a weighting agent was prepared for comparison. The emulsion compositions were prepared using seven different flavorant formulations. A listing of flavorant formulations tested, their flavor profiles, and their general chemical composition is provided in Table 1 below:

TABLE 1

| Flavorant | | |
|---|---|---|
| Formulation | Flavor profile | Chemical composition |
| A | Red Cherry | Terpenes, esters, aldehydes, volatile sulfur compounds |
| B | Chamomile | Natural extract (terpenoids) |
| C | Grapefruit | Esters, aldehydes, volatile sulfur compounds |
| D | Guava | Terpenes, esters, aldehydes, volatile sulfur compounds |
| E | Passionfruit | Terpenes, esters, aldehydes, volatile sulfur compounds |
| F | El Dorado hops | Terpenes, esters, aldehydes, volatile sulfur compounds |
| G | Cascade hop | Terpenes, esters, aldehydes, volatile sulfur compounds |

Using the procedure described in Examples 1 and 2, six emulsion systems were prepared, including one weighting agent—containing control (EMP-01A) and five weighting agent/gum acacia free emulsion systems (EMP-01B-EMP-01F), for use in combination with the five flavorant formulations A-E from Table 1, to study effect of changing emulsion systems and flavorants on emulsion properties of the resulting emulsion compositions. The emulsion compositions prepared using different flavorants in the control emulsion system EMP-01A are provided in Table 2, while the remaining compositions prepared using different flavorants in the inventive emulsion systems (EMP-01B-EMP-01F) are listed in Tables 3-7. All amounts are in wt. %, based in the total weight of the emulsion composition, unless otherwise specified.

TABLE 2

| | | Emulsion System - EMP-01A | | | | |
|---|---|---|---|---|---|---|
| | | | Ticaloid | | | |
| Flavorant | | | Acacia | Potassium | Ester | Water, |
| Formulation | wt.% | Citric acid | Max | Sorbate | Gum* | Distilled |
| A | 2 | 0.03 | 2 | 0.1 | 1.27 | 94.6 |
| B | 2 | 0.03 | 2 | 0.1 | 0.31 | 95.56 |
| C | 2 | 0.03 | 2 | 0.1 | 1.68 | 94.19 |
| D | 2 | 0.03 | 2 | 0.1 | 0.63 | 95.24 |
| E | 2 | 0.03 | 2 | 0.1 | 1.14 | 94.73 |

*Ester gum content is variable due to the differences in the density of the flavorant oil.

TABLE 3

| | | Emulsion System - EMP-01B | | | | | | |
|---|---|---|---|---|---|---|---|---|
| | | | | | Alpha | | | |
| Flavorant | | Ascorbic | Citric | Potassium | Extract | Sunlipon® | | Water, |
| Formulation | wt. % | acid | Acid | Citrate | 20% | 65 | MCT | Distilled |
| A | 2 | 0.05 | 0.04 | 0.07 | 0.01 | 1.00 | 1.00 | 95.83 |
| B | 2 | 0.05 | 0.04 | 0.07 | 0.01 | 1.00 | 1.00 | 95.83 |
| C | 2 | 0.05 | 0.04 | 0.07 | 0.01 | 1.00 | 1.00 | 95.83 |
| D | 2 | 0.05 | 0.04 | 0.07 | 0.01 | 1.00 | 1.00 | 95.83 |
| E | 2 | 0.05 | 0.04 | 0.07 | 0.01 | 1.00 | 1.00 | 95.83 |

TABLE 4

| | | Emulsion System - EMP-01C | | | | | | | |
|---|---|---|---|---|---|---|---|---|---|
| Flavorant | | | | | Alpha | | | | |
| | wt. | Ascorbic | Citric | Potassium | Extract | Sunlipon® | | | Water, |
| Formulation | % | acid | Acid | Citrate | 20% | 65 | MCT | Trehalose | Distilled |
| A | 2 | 0.02 | 0.04 | 0.07 | 0.01 | 1.00 | 1.00 | 5.00 | 90.86 |
| B | 2 | 0.02 | 0.04 | 0.07 | 0.01 | 1.00 | 1.00 | 5.00 | 90.86 |
| C | 2 | 0.02 | 0.04 | 0.07 | 0.01 | 1.00 | 1.00 | 5.00 | 90.86 |
| D | 2 | 0.02 | 0.04 | 0.07 | 0.01 | 1.00 | 1.00 | 5.00 | 90.86 |
| E | 2 | 0.02 | 0.04 | 0.07 | 0.01 | 1.00 | 1.00 | 5.00 | 90.86 |

TABLE 5

| | | Emulsion System - EMP-01D | | | | |
|---|---|---|---|---|---|---|
| Flavorant | | Sunlipon® | Citric | Potassium | Sodium | Water, |
| Formulation | wt. % | 65 | acid | Sorbate | citrate | Distilled |
| A | 2 | 1 | 0.03 | 0.1 | 0.06 | 96.81 |
| B | 2 | 1 | 0.03 | 0.1 | 0.06 | 96.81 |
| C | 2 | 1 | 0.03 | 0.1 | 0.06 | 96.81 |
| D | 2 | 1 | 0.03 | 0.1 | 0.06 | 96.81 |
| E | 2 | 1 | 0.03 | 0.1 | 0.06 | 96.81 |

TABLE 6

| | | Emulsion System - EMP-01E | | | | | | |
|---|---|---|---|---|---|---|---|---|
| | | | | | | Potassium | | |
| | | | | | | Alpha | | |
| Flavorant | | | Ascorbic | Citric | Sodium | Extract | Sunlipon® | Water, |
| Formulation | wt. % | Trehalose | acid | acid | citrate | 20% | 65 | Distilled |
| A | 2 | 5.00 | 0.02 | 0.04 | 0.07 | 0.01 | 1 | 91.86 |
| B | 2 | 5.00 | 0.02 | 0.04 | 0.07 | 0.01 | 1 | 91.86 |
| C | 2 | 5.00 | 0.02 | 0.04 | 0.07 | 0.01 | 1 | 91.86 |
| D | 2 | 5.00 | 0.02 | 0.04 | 0.07 | 0.01 | 1 | 91.86 |
| E | 2 | 5.00 | 0.02 | 0.04 | 0.07 | 0.01 | 1 | 91.86 |

TABLE 7

| | | Emulsion System - EMP-01F | | | | | | | |
|---|---|---|---|---|---|---|---|---|---|
| | | | | | | Potassium | | | |
| | | | | | | Alpha | | | |
| Flavorant | | | Ascorbic | Citric | Potassium | Extract | Sunlipon® | Sunflower | Water, |
| Formulation | wt. % | Trehalose | acid | Acid | Citrate | 20% | 65 | seed oil | Distilled |
| A | 2 | 5.00 | 0.02 | 0.04 | 0.07 | 0.01 | 1.00 | 1.00 | 90.86 |
| B | 2 | 5.00 | 0.02 | 0.04 | 0.07 | 0.01 | 1.00 | 1.00 | 90.86 |
| C | 2 | 5.00 | 0.02 | 0.04 | 0.07 | 0.01 | 1.00 | 1.00 | 90.86 |
| D | 2 | 5.00 | 0.02 | 0.04 | 0.07 | 0.01 | 1.00 | 1.00 | 90.86 |
| E | 2 | 5.00 | 0.02 | 0.04 | 0.07 | 0.01 | 1.00 | 1.00 | 90.86 |

### Example 6: Stability Analysis of Oil-In-Water Emulsions with Varying Emulsion Systems

The inventive and comparative emulsion formulations prepared using the methods described in Examples 1 and 2 were tested for parameters like particle size, stability, and consistency.

Keeping the flavorant formulation constant, various emulsion compositions containing control emulsion system (EMP-01A) and inventive emulsion systems (EMP-01B-EMP-01F) were studied to understand the effect of different emulsion systems on the of turbidity (NTU) and particle size distribution data (d50 and 90 (μm)). The results are summarized in the Tables 8-12 below.

TABLE 8

| | Flavorant | Turbidity | d50 | d90 |
|---|---|---|---|---|
| Emulsion System | Formulation | (NTU) | (μm) | (μm) |
| EMP-01A (Control) | A | 18.2 | 0.209 | 0.328 |
| EMP-01B | A | 22.2 | 0.154 | 0.201 |
| EMP-01C | A | 10.3 | 0.179 | 0.2597 |
| EMP-01D | A | 1.23 | 0.2992 | 0.4372 |
| EMP-01E | A | 4.05 | 0.139 | 0.206 |
| EMP-01F | A | 18 | 0.152 | 0.223 |

TABLE 9

| | Flavorant | Turbidity | d50 | d90 |
|---|---|---|---|---|
| Emulsion System | Formulation | (NTU) | (μm) | (μm) |
| EMP-01A (Control) | B | 97.2 | 0.294 | 0.418 |
| EMP-01B | B | 13.7 | 0.164 | 0.218 |
| EMP-01C | B | 5.47 | 0.204 | 0.3013 |
| EMP-01D | B | 1.26 | 0.137 | 0.2052 |
| EMP-01E | B | 1.91 | 0.133 | 0.196 |
| EMP-01F | B | 9.47 | 0.145 | 0.2183 |

TABLE 10

| | Flavorant | Turbidity | d50 | d90 |
|---|---|---|---|---|
| Emulsion System | Formulation | (NTU) | (μm) | (μm) |
| Emp-01A (Control) | C | 190 | 0.2808 | 0.4228 |
| Emp-01B | C | 29.5 | 0.149 | 0.211 |
| Emp-01C | C | 20.5 | 0.152 | 0.228 |
| Emp-01D | C | 6.54 | 0.118 | 0.175 |
| Emp-01E | C | 24.2 | 0.1262 | 0.1908 |
| Emp-01F | C | 27.1 | 0.1487 | 0.222 |

TABLE 11

| | Flavorant | Turbidity | | |
|---|---|---|---|---|
| Emulsion System | Formulation | (NTU) | d50 | d90 |
| Emp-01A (Control) | D | 60.6 | 0.3103 | 0.4352 |
| Emp-01B | D | 32.1 | 0.147 | 0.184 |
| Emp-01C | D | 12.7 | 0.145 | 0.217 |
| Emp-01D | D | 6.94 | 0.123 | 0.1858 |
| Emp-01E | D | 6.99 | 0.137 | 0.2088 |
| Emp-01F | D | 12.9 | 0.138 | 0.206 |

TABLE 12

| | Flavorant | Turbidity | | |
|---|---|---|---|---|
| Emulsion System | Formulation | (NTU) | d50 | d90 |
| Emp-01A (Control) | E | 89.9 | 0.3028 | 0.434 |
| Emp-01B | E | 21.2 | 0.134 | 0.17 |
| Emp-01C | E | 9.09 | 0.159 | 0.24 |
| Emp-01D | E | 11.5 | 0.148 | 0.22 |
| Emp-01E | E | 4.71 | 0.149 | 0.222 |
| Emp-01F | E | 11.7 | 0.148 | 0.22 |

As can be seen from the above results, the turbidity for the control emulsion system containing weighting agent, EMP-01A, exhibits higher turbidity (NTU) as well as higher mean particle size, d50 (nm), and 10% of the larger particles in the sample are significantly higher in size (d90, nm) versus the inventive emulsion compositions which are free of weighting agents (EMP-01B-EMP-01F).

### Example 7. Stability Analysis of Oil-In-Water Emulsions with Varying Flavorant Formulations

To understand how different flavorants behave across the same emulsion system, emulsion compositions were prepared using various flavorant formulations in combination with each emulsion systems (EMP-01A-EMP-01F) and their properties, such as turbidity and particle size distribution, were studied. The results are summarized in the Tables 13-18 below.

TABLE 13

| Flavorant | Emulsion | | | |
|---|---|---|---|---|
| Formulation | System | Turbidity | d50 | d90 |
| A | Emp-01A | 18.2 | 0.209 | 0.328 |
| B | Emp-01A | 97.2 | 0.294 | 0.418 |
| C | Emp-01A | 190 | 0.2808 | 0.4228 |
| D | Emp-01A | 60.6 | 0.3103 | 0.4352 |
| E | Emp-01A | 89.9 | 0.3028 | 0.434 |

TABLE 14

| Flavorant | Emulsion | | | |
|---|---|---|---|---|
| Formulation | System | Turbidity | d50 | d90 |
| A | Emp-01B | 22.2 | 0.154 | 0.201 |
| B | Emp-01B | 13.7 | 0.164 | 0.218 |
| C | Emp-01B | 29.5 | 0.149 | 0.211 |
| D | Emp-01B | 32.1 | 0.147 | 0.184 |
| E | Emp-01B | 21.2 | 0.134 | 0.17 |

TABLE 15

| Flavorant | Emulsion | | | |
|---|---|---|---|---|
| Formulation | System | Turbidity | d50 | d90 |
| A | Emp-01C | 10.3 | 0.179 | 0.2597 |
| B | Emp-01C | 5.47 | 0.204 | 0.3013 |
| C | Emp-01C | 20.5 | 0.152 | 0.228 |
| D | Emp-01C | 12.7 | 0.145 | 0.217 |
| E | Emp-01C | 9.09 | 0.159 | 0.24 |

TABLE 16

| Flavorant | Emulsion | | | |
|---|---|---|---|---|
| Formulation | System | Turbidity | d50 | d90 |
| A | Emp-01D | 1.23 | 0.2992 | 0.4372 |
| B | Emp-01D | 1.26 | 0.137 | 0.2052 |
| C | Emp-01D | 6.54 | 0.118 | 0.175 |
| D | Emp-01D | 6.94 | 0.123 | 0.1858 |
| E | Emp-01D | 11.5 | 0.148 | 0.22 |

TABLE 17

| Flavorant | Emulsion | | | |
|---|---|---|---|---|
| Formulation | System | Turbidity | d50 | d90 |
| A | Emp-01E | 4.05 | 0.139 | 0.206 |
| B | Emp-01E | 1.91 | 0.133 | 0.196 |
| C | Emp-01E | 24.2 | 0.1262 | 0.1908 |
| D | Emp-01E | 6.99 | 0.137 | 0.2088 |
| E | Emp-01E | 4.71 | 0.149 | 0.222 |

TABLE 18

| Flavorant | Emulsion | | | |
|---|---|---|---|---|
| Formulation | System | Turbidity | d50 | d90 |
| A | Emp-01F | 18 | 0.152 | 0.223 |
| B | Emp-01F | 9.47 | 0.145 | 0.2183 |
| C | Emp-01F | 27.1 | 0.1487 | 0.222 |
| D | Emp-01F | 12.9 | 0.138 | 0.206 |
| E | Emp-01F | 11.7 | 0.148 | 0.22 |

The above results demonstrate that the inventive emulsions are minimally affected by the flavor compositions, showing similar reduced turbidities and particle size distribution within each emulsion system. Further, on average, the inventive emulsions, for each flavor have lower turbidities and particle size distributions when compared to the control emulsion. These data show that the inventive emulsions can incorporate a diverse range of flavorant formulations while retaining stability.

### Example 8. Stability Analysis of Oil-In-Water Emulsions with Hops Essential Oils

To understand how different hop flavorants behave across similar emulsion systems, emulsions containing hop oil flavorants were prepared and their properties were studied as a function of hop flavor and emulsion system. The hop flavorants (6 and 7) were emulsified using a 5% hop oil load in the emulsion systems EMP-01A (control) and EMP-01D (inventive emulsion system), as summarized in Tables 19 and 20 below.

TABLE 19

| | | Emulsion System - EMP-01A′ | | | | |
|---|---|---|---|---|---|---|
| | | | | Natural | | |
| | | | Ticaloid | Citrus Ext, | | |
| Flavorant | | Citric | Acacia | FoodGARD - | Ester | Water, |
| Formulation | wt. % | Acid | Max | Biosecure | Gum | Distilled |
| F | 5 | 0.03 | 4 | 0.2 | 5.912 | 84.858 |
| G | 5 | 0.03 | 4 | 0.2 | 5.794 | 84.976 |

TABLE 20

| | | Emulsion System - EMP-01D | | | | |
|---|---|---|---|---|---|---|
| Flavorant | | Sunlipon R | Citric | Potassium | Sodium | Water, |
| Formulation | wt. % | 65 | Acid | Sorbate | Citrate | Distilled |
| F | 5 | 2.5 | 0.03 | 0.2 | 0.07 | 92.2 |
| G | 5 | 2.5 | 0.03 | 0.2 | 0.07 | 92.2 |

Turbidity and particle size analysis were conducted on the control and inventive hop oil emulsions shown in Tables 19 and 20. The results of the tests are summarized in Table 21 below.

TABLE 21

| | Flavorant | Turbidity | d50 | d90 |
|---|---|---|---|---|
| Emulsion System | Formulation | (NTU) | (μm) | (μm) |
| Emp-01A′ (Control) | F | 294 | 0.209 | 0.328 |
| Emp-01D | F | 51.1 | 0.149 | 0.223 |
| Emp-01A′ (Control) | G | 343 | 0.2584 | 0.4115 |
| Emp-01D | G | 23.3 | 0.135 | 0.209 |

The results show that hops flavors can be efficiently emulsified using the inventive emulsions, without the use of weighting agents and/or gum acacia. For example, the turbidity in the control emulsions was observed to be upwards of over 300 NTU, whereas the highest turbidity of the inventive emulsion composition was at most ˜51 NTU for flavor composition 5. Furthermore, the particle size in the inventive emulsions compositions the inventive emulsion compositions, which are free of weighting agents, are smaller than the control, further indicating an improved emulsion stability.

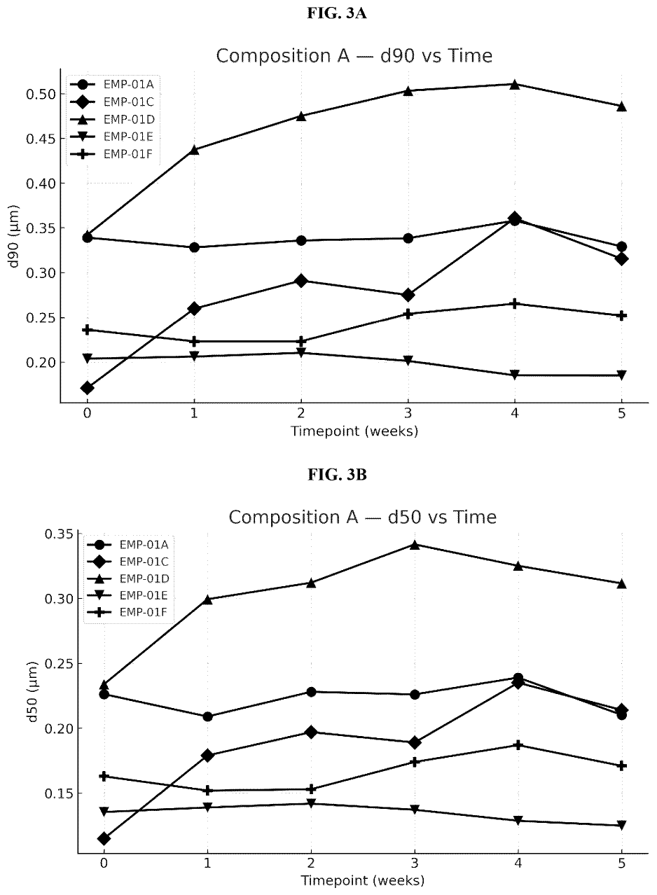

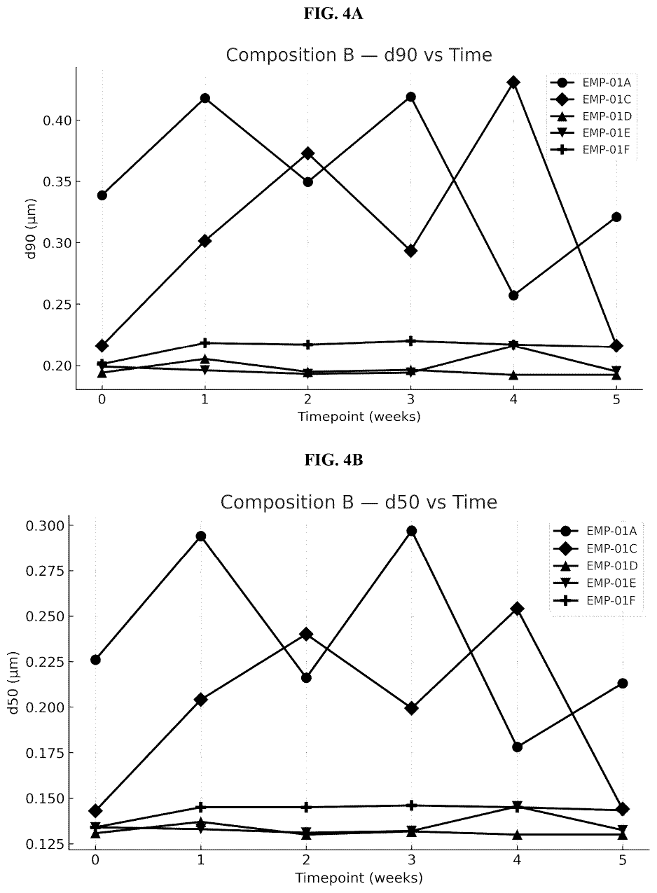

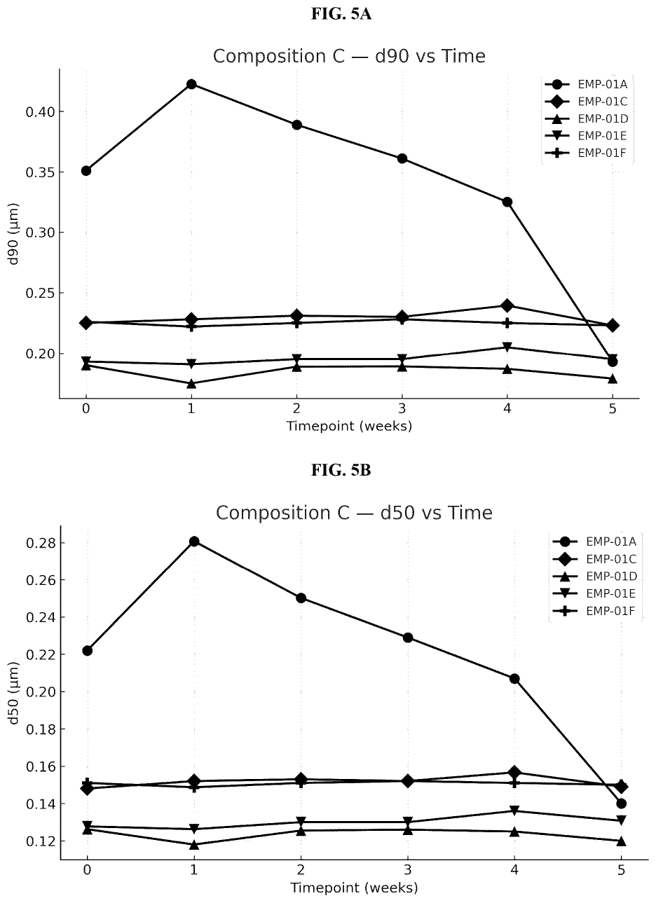

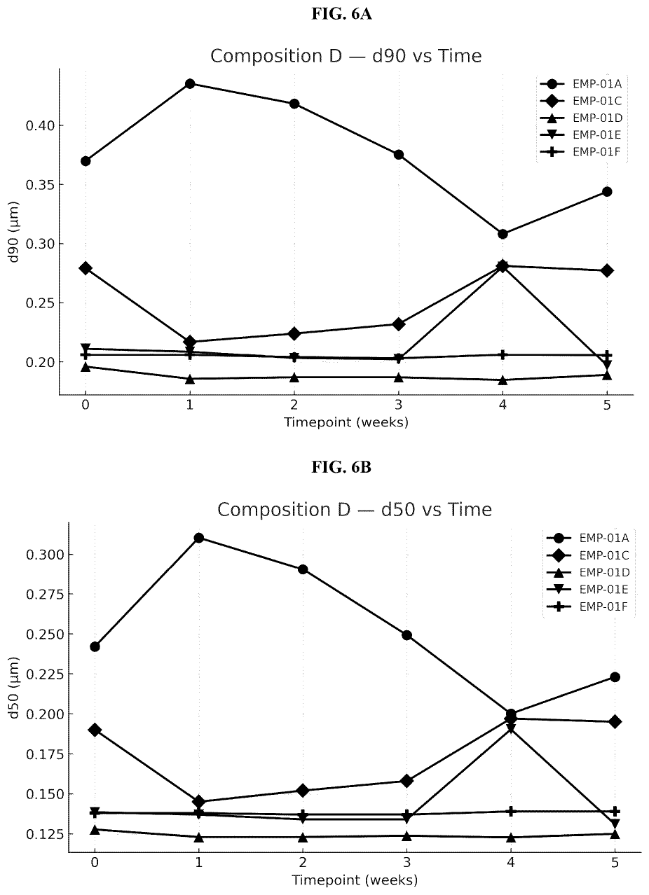

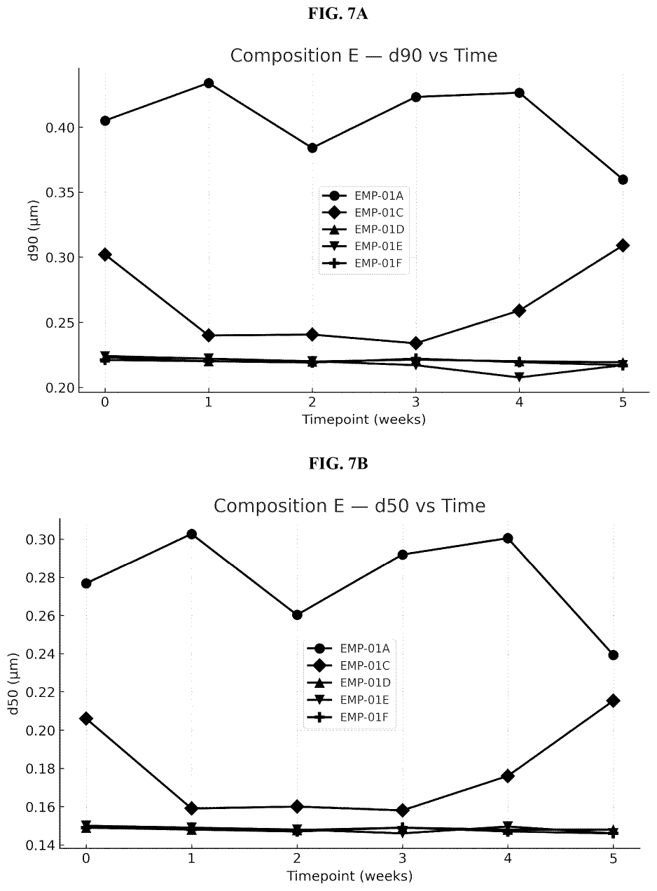

Following the finding of lower turbidities and smaller particle size distributions for the inventive emulsion compositions, accelerated shelf-life testing was conducted to determine how each flavorant formulation changed as a function of emulsion system over time. FIGS. 3-7 shows accelerated shelf-life (ASL) study emulsions test data for emulsion storage at 0-5 weeks at 45° C. The ASL oil-in-water emulsions show superior performance in the PSA and turbidity measurements, maintaining smaller d10, d50, and d90 particle size distributions over the gum sample control and lower turbidity. These graphs showcase how the particle size characteristics (d50 and d90) of the inventive examples (EMP-01B-EMP-01F) have substantial reduction in size relative to the control, EMP-01A. For instance, flavor composition E has a ˜36% reduction in d50 in EMP-01C versus the control, EMP-01A.

In illustrative formulations, the inventive emulsions maintained d50 values within about 0.14-0.20 μm and turbidity increases ≤˜10-15 NTU after 4-5 weeks at 45° C., outperforming matched controls without weighting agents. This synergy between one or more of (a) phospholipid emulsifiers, (b) low level acid/salt emulsifier adjuvants, (c) optional triglyceride oils, and (d) trehalose or similar sugars was not suggested by conventional gum/weighting agent systems and further demonstrates that long term clarity and stability can be achieved without the use of weighting agents and/or gum acacia.

### Example 9: Sensory Analysis

Panel, Oversight, and Eligibility. Ten adult panelists (5 female, 5 male) company scientists (analytical, flavor, and applications)—participated as trained internal experts. Participation was voluntary with no compensation. The activity was reviewed by the company's sensory administrator as an internal, minimal-risk product test (no external IRB). Eligibility required normal taste/olfactory function; no upper-respiratory infection within 7 days; no known allergies to test materials; and abstention from eating strong flavors for ≥1 hour prior to testing. Pre-session screening confirmed eligibility.

Study Design. Randomized, blinded, within-subjects design. Each panelist evaluated six aqueous emulsion samples in one session. Samples were presented in randomized order with blinding codes. Panelists observed, smelt, and ingested each sample. Inter-sample interval ˜60-90 s with water rinses. Standardized written instructions were provided. Flavor composition H was used for all samples with varying emulsion systems.

Product Preparation and Serving. Samples were prepared by diluting each emulsion solution into water at 1% dosing. Solutions were stirred for 5 minutes and refrigerated until required. 50 mL was transferred into plastic cups for individuals.

Measurements and Scales. Panelists evaluated each sample using standardized 0-100 line scales captured electronically. Appearance was rated for turbidity (0=clear/none; 100=very cloudy/opaque) and appearance pleasantness (0=extremely unpleasant; 100=extremely pleasant). Aroma was rated for aroma intensity (0=none; 100=extremely intense) and aroma pleasantness (0=extremely unpleasant; 100=extremely pleasant); panelists recorded any aroma off-notes in a free-text field (open response). Flavor was rated for overall flavor liking (“how good it is”; 0=dislike extremely; 100=like extremely), sweetness intensity (0=none; 100=extremely sweet), and bitterness intensity (0=none; 100=extremely bitter); panelists recorded any flavor off-notes in a free-text field. Mouthfeel was rated for mouthfeel pleasantness (0=extremely unpleasant; 100=extremely pleasant) and waxy/oily character (0=not waxy/oily; 100=extremely waxy/oily). Finally, an overall impression/overall liking score was collected on a 0-100 scale (0=dislike extremely; 100=like extremely). All anchors were visible on screen; unless otherwise noted, higher scores indicate greater intensity or greater liking, as applicable.

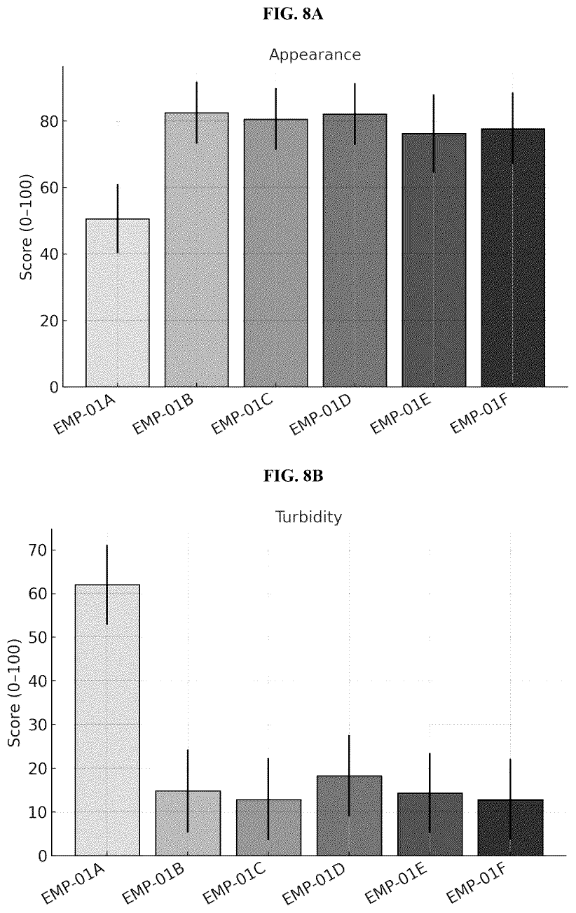

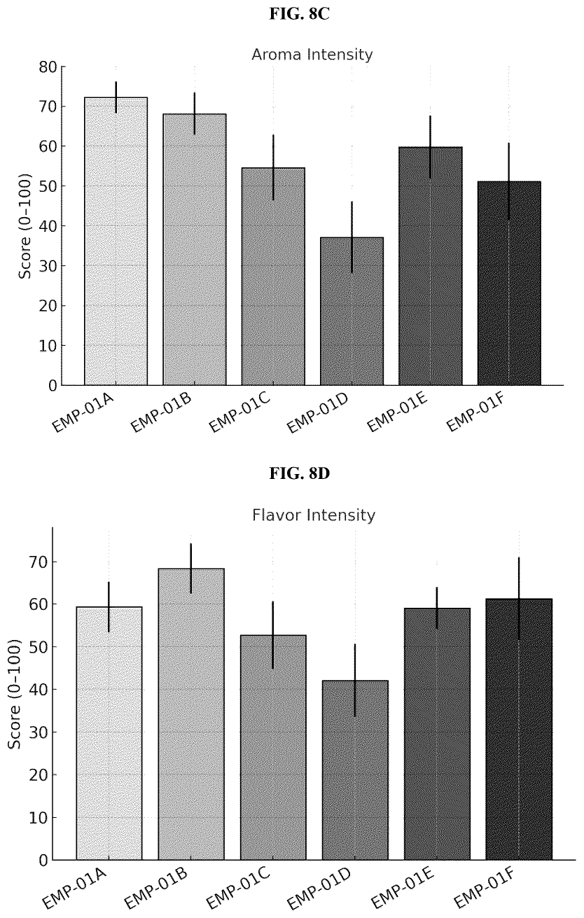

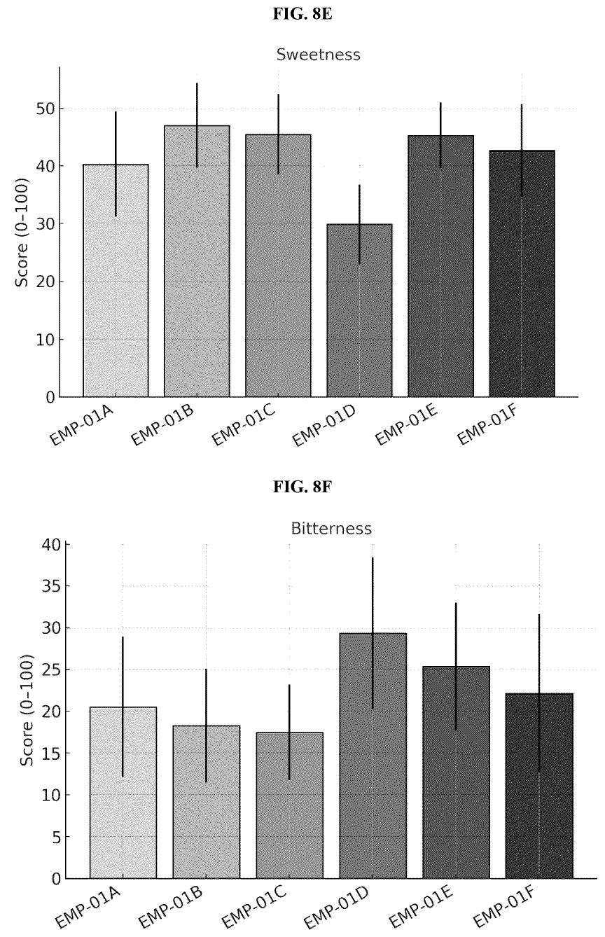

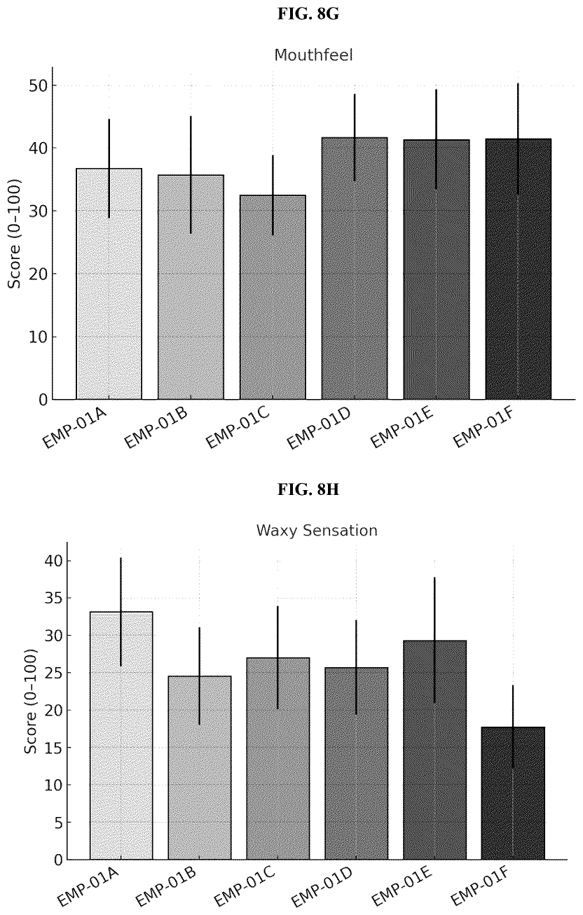

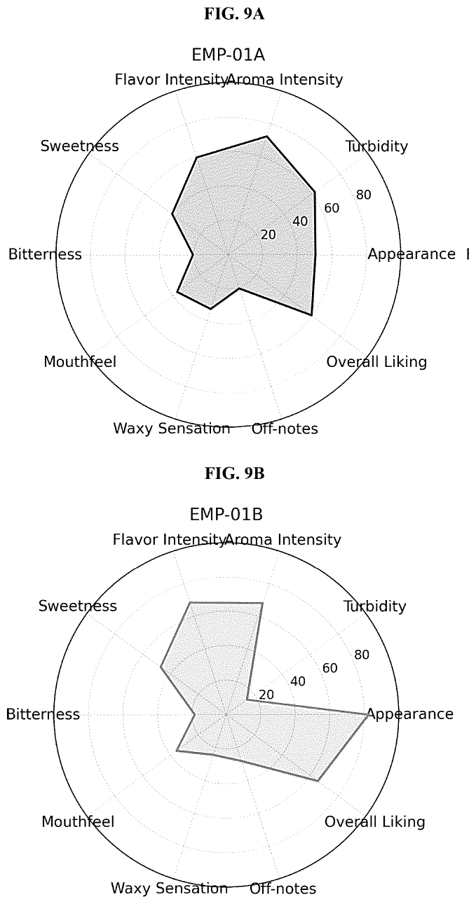

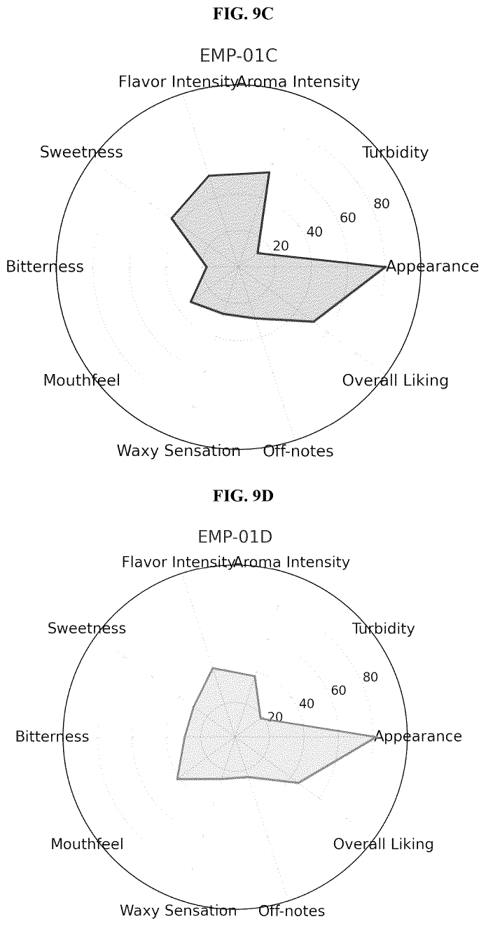

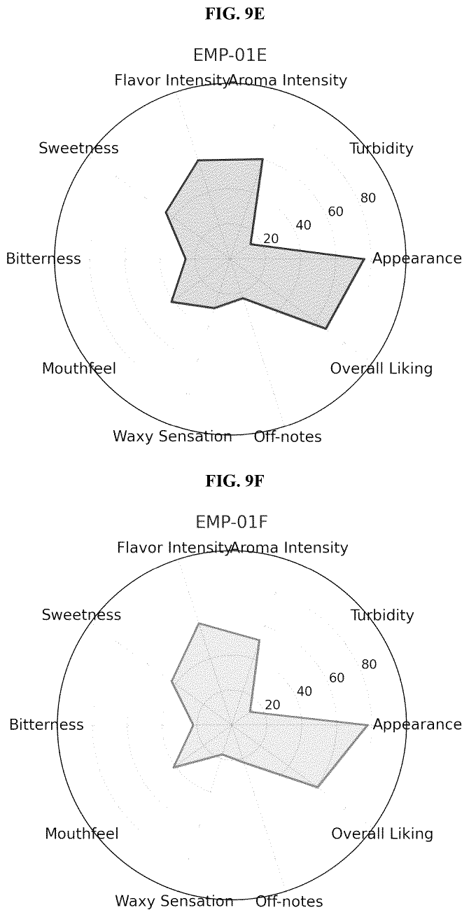

FIGS. 8A-8H show bar and error plots of each sample for each sensory test. FIGS. 9A-9F show spider plots illustrating sensory attributes perceived by the users.

### Results.

Visual performance. Relative to gum acacia (EMP-01A), the prototype systems exhibited marked improvements in perceived visual quality:
Appearance: Prototype means were consistently higher than EMP-01A (prototype range≈mid-70s to low-80s vs ˜50 for EMP-01A), indicating a clearer, more appealing visual presentation (FIGS. 1-2). Across the six groups, the numeric elevation in Appearance did not reach significance at α=0.05 by ANOVA/Tukey (i.e., improvements are directional but not statistically conclusive given panel size and variance).
Turbidity: Prototypes showed substantially lower turbidity (prototype means≈low-teens to ˜30 vs ˜62 for EMP-01A), consistent with reduced haze. ANOVA detected a significant sample effect for Turbidity, and Tukey-Kramer grouped multiple prototypes into a lower-turbidity class distinct from EMP-01A (CLD: prototypes vs 01A, p<0.05). This supports a statistically demonstrable improvement in clarity.

Flavor, aroma, and texture. Across non-visual attributes, prototypes generally retained or improved sensory performance relative to EMP-01A:
Aroma and flavor intensity: Several prototypes (notably EMP-01B and EMP-01E, with EMP-01F close) displayed equal or higher mean Flavor Intensity and Aroma Intensity versus EMP-01A; EMP-01D trailed the set on both intensity measures (FIGS. 1-2).
Sweetness/Bitterness: Sweetness was comparable to modestly higher than EMP-01A for most prototypes; Bitterness remained within the same band as the control, with EMP-01D showing the highest mean bitterness among the set.
Mouthfeel, waxy sensation, off-notes: Group means remained in mid-range values without prototypical penalties versus EMP-01A. Importantly, EMP-01A had a higher perceived waxiness mean than the other samples, indicating improved overall texture in the inventive emulsions.

Hedonics and exploratory drivers. Mean Overall Liking for EMP-01B and EMP-01E exceeded EMP-01A numerically, while EMP-01F was similar and EMP-01C/EMP-01D were lower. However, between-sample differences in Overall Liking did not reach statistical significance (Tukey CLD shared letters at α=0.05). An exploratory, cross-sample correlation (based on means) indicated positive associations between liking and Flavor Intensity, Sweetness, and Aroma Intensity, and a negative association with Bitterness.

The inventive emulsions demonstrate clear, statistically supported reductions in Turbidity relative to a gum-acacia control (FIG. 8B), with directionally higher Appearance scores and no systematic trade-offs in flavor, aroma, or mouthfeel. Among prototypes, EMP-01B and EMP-01E best combine the visual improvements with strong flavor/aroma profiles and numerically higher liking.

It was observed that EMP-01A had the highest aroma intensity as ranked by the panelists (FIG. 8C), indicating the oil-phase flavor components may not be as well retained, and could potentially have a more rapid reduction in flavor over time. The overall sensory characteristics measured, as shown in FIGS. 9B-9F, are similar for each of the inventive emulsions, show casing how they can retain beneficial characteristics without the turbidity of the gum-containing control EMP-01A emulsion (FIG. 9A).

### Example 10: HS-SPME-GC×GC-TOF-MS Analysis

Volatile constituents of the emulsion were analyzed by HS-SPME coupled to comprehensive two-dimensional gas chromatography and time-of-flight mass spectrometry (GC×GC-TOFMS) using a Centri sample preparation platform (Markes International Ltd., Bridgend, UK) interfaced with an Agilent 8890 gas chromatograph and BenchTOF mass spectrometer (Markes International Ltd.). Aliquots of the emulsion (100 μL) were transferred directly into clean 20 mL glass headspace vials (Agilent Technologies) sealed with PTFE/silicone septa. No salt, solvent, or buffer was added. The vials contained no stirring elements, and the fiber was positioned in the headspace above the liquid sample. Samples were equilibrated at ambient laboratory temperature (˜22° C.) for 5 min prior to extraction. Following extraction, the fiber was inserted directly into the Centri system for splitless thermal desorption. The desorption trap temperature was ramped from ambient to 280° C. (10° C. s⁻¹) and held for 4 min. Pre-purge, trap purge, and re-collection steps followed the parameters listed in the instrument method file (trap purge flow=50 mL min⁻¹, trap purge time=3 min, trap low temperature=20° C.). The desorbed analytes were transferred to the GC inlet held at 250° C. Chromatographic separations were performed on a two-column configuration consisting of a first-dimension column (20 m×180 μm×0.18 μm) and a second-dimension column (4.8 m×320 μm×0.15 μm) connected via a flow modulator (INSIGHT Modulator, Markes International). Helium was used as the carrier gas at a constant flow of 0.51 mL min⁻¹. The oven program began at 40° C. (3 min hold), ramped at 10° C. min⁻¹ to 150° C. (2 min hold), then 1.5° C. min⁻¹ to 270° C. (1 min hold), followed by 20° C. min⁻¹ to 325° C. (final hold 1 min). The total run time was 84.3 min. Detection was performed using a BenchTOF mass spectrometer operated in continuous acquisition mode under electron ionization (70 eV). The transfer line and ion source were maintained at 260° C. and 280° C., respectively. Data were analyzed using ChromSpace (Markes International).

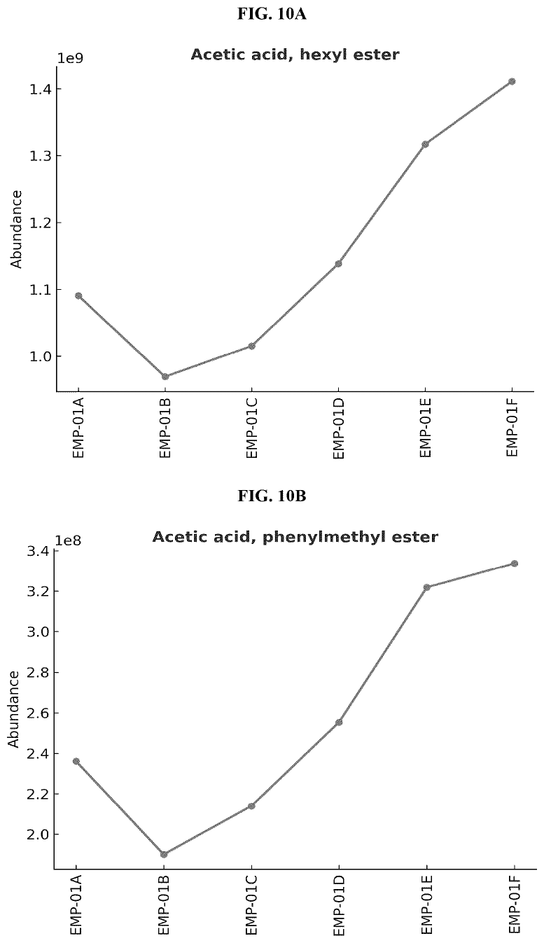

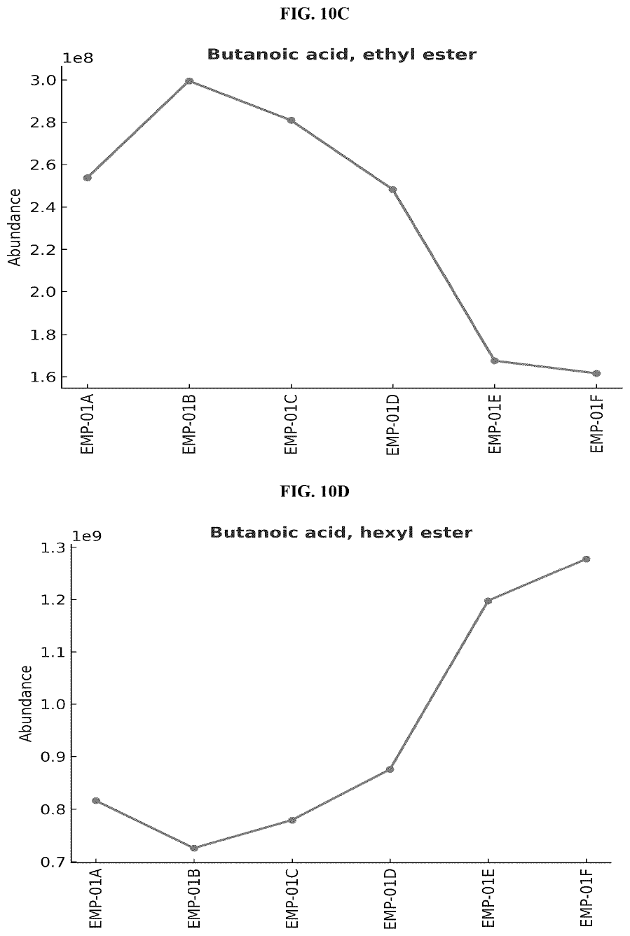

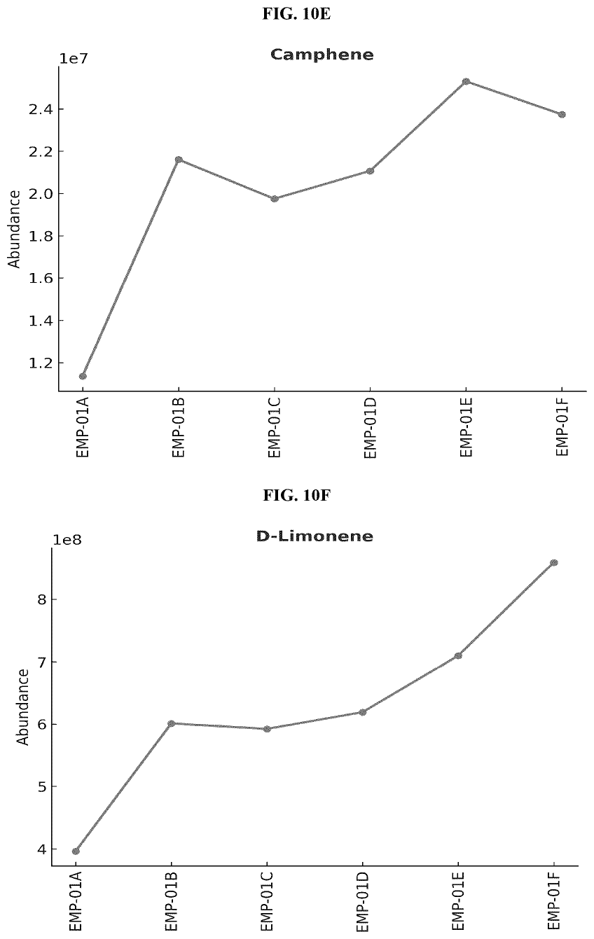

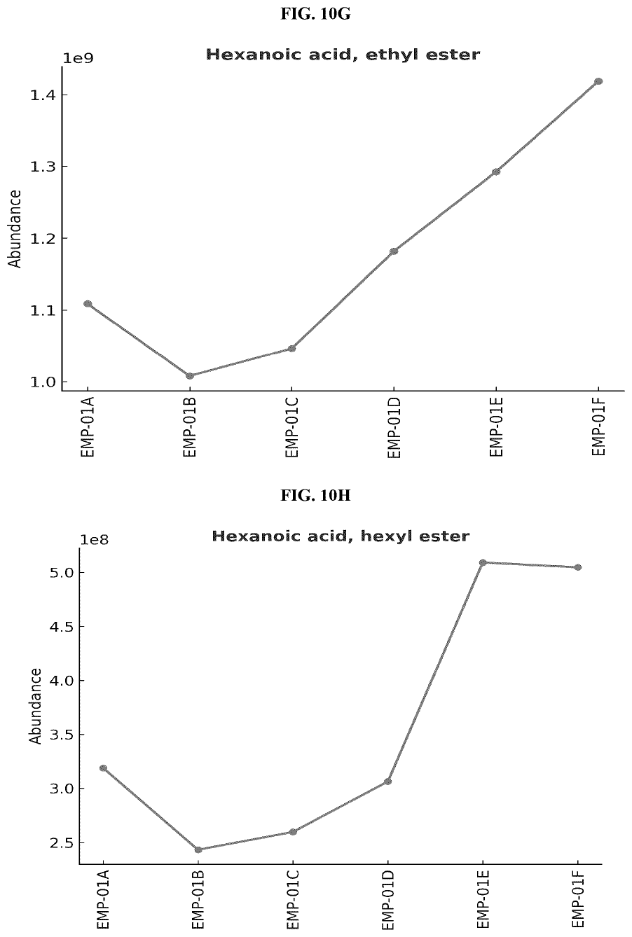

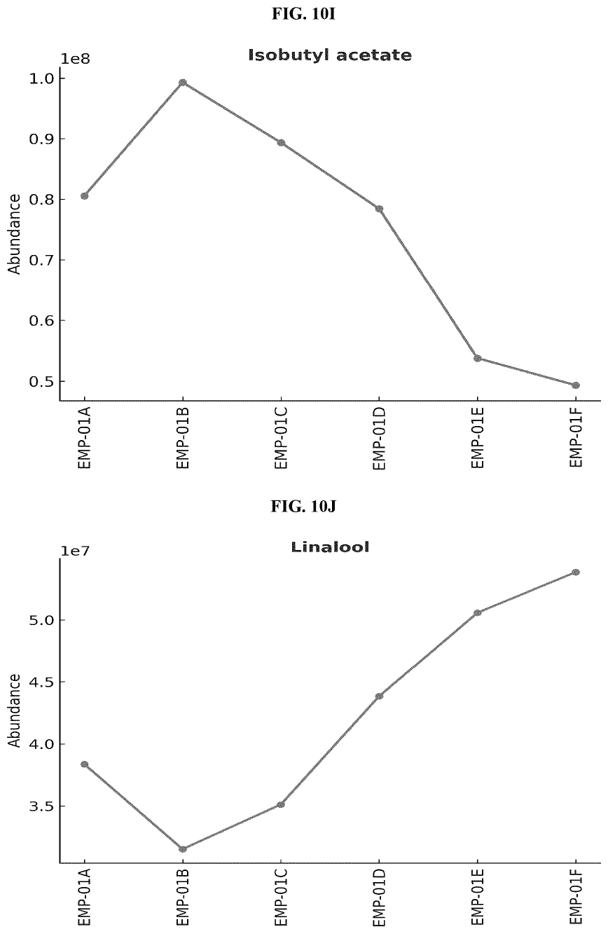

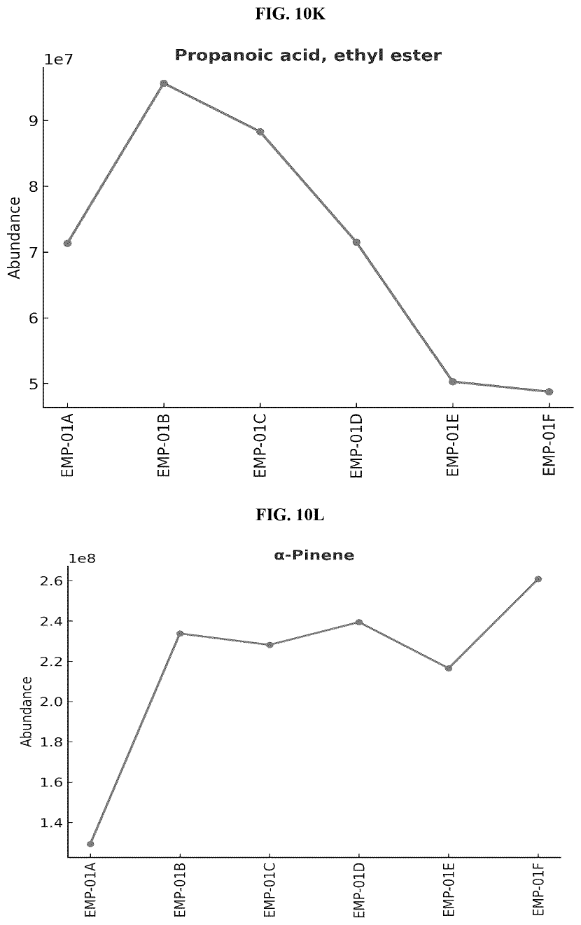

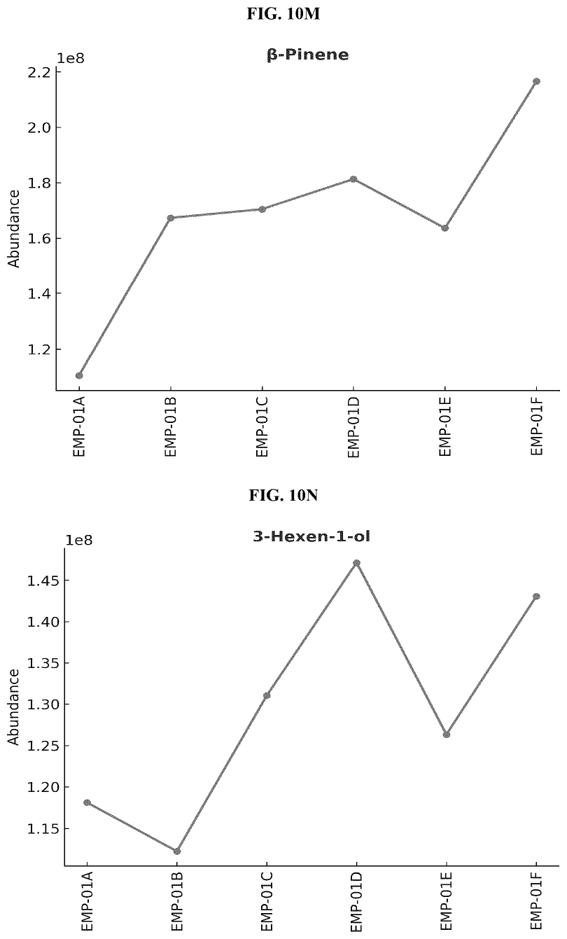

Effect of Treatment on Volatile Compound Release: The HS-SPME-GC×GC-TOFMS data revealed that the volatile release profile of the emulsion was strongly dependent on treatment conditions, as illustrated in FIGS. 10A-10N. Different chemical classes were observed to have different abundance in the gas phase, with compounds such as acetic acid, hexyl ester and acetic acid, phenylmethyl ester having higher concentrations in EMP-01D-EMP-01F compared to EMP-01A-EMP-01C. Conversely, other compounds such as butanoic acid, ethyl ester and isobutyl acetate had lower levels for EMP-01E-EMP-01F compared with EMP-01A-EMP-01D. These results demonstrate that the various inventive emulsions can be chosen and fine-tuned based on the flavor composition to inhibit or release certain compounds, adding yet another variable of control over traditional gum-based technologies.

Across treatments EMP-01B through EMP-01F, distinct trends were observed for multiple chemical classes, including short-chain esters, terpenes, and higher alcohols, whereas low-molecular-weight esters such as propanoic acid, ethyl ester and isobutyl acetate exhibited maximum headspace abundance under early treatments (EMP-01A-EMP-01F) before declining sharply at higher treatment levels (EMP-01C-EMP-01F)). In contrast, mid- to long-chain esters (e.g., hexanoic acid, ethyl ester; acetic acid, hexyl ester; butanoic acid, hexyl ester) and phenolic esters displayed a progressive increase in headspace abundance with treatment intensity, reaching maxima at EMP-01C-EMP-01F). Terpenoid volatiles showed similar treatment-specific trends. α-Pinene, β-pinene, and camphene exhibited moderate variation across treatments but increased under higher treatment conditions (EMP-01C-EMP-01F), whereas D-limonene and linalool displayed continuous enrichment throughout the treatment progression, indicating a steady rise in monoterpene abundance. Notably, 3-hexen-1-ol and its acetate derivative increased substantially at elevated treatments. Overall, these results demonstrate that emulsion treatment parameters can be strategically used to modulate volatile release kinetics, controlling both which compounds dominate the aroma headspace and when they are released during processing or consumption. Early treatments favor the liberation of low-boiling esters, contributing to bright, fruity notes, whereas later treatments promote the emergence of higher molecular weight esters and terpenes, responsible for deeper, more persistent aromatic characteristics. Such tunable release behavior underscores the potential for controlled flavor delivery through emulsion engineering.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from their spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

As will be understood by one skilled in the art, for any and all purposes, particularly in terms of providing a written description, “one or more of A, B and C,” or “at least one of A, B and C,” should be understood to mean “only A, only B, only C, both A and B, or both A and C, or both B and C, or all three of A, B and C” as used herein.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An oil-in-water emulsion composition comprising:
an oil phase comprising:
about 0.01 wt. % to about 30 wt. %, based on a total weight of the emulsion composition, of a flavorant; and
about 0.01 wt. % to about 10 wt. %, based on the total weight of the emulsion composition, of an emulsifier adjuvant; and
a continuous aqueous phase comprising:
water; and
about 0.01 wt. % to about 10 wt. %, based on the total weight of the emulsion composition, of an emulsifying agent;
wherein the oil-in-water emulsion composition is substantially free of weighting agents and gum acacia.

2. The oil-in-water emulsion composition of claim 1, wherein the oil phase comprises about 0.01 wt. % to about 10 wt. %, based on the total weight of the emulsion composition, of a flavorant.

3. The oil-in-water emulsion composition of claim 1, wherein the flavorant comprises one or more of a hop oil, a cannabis oil, a hemp oil, a hop extract, a terpene blend, a hop-derived flavorant compound, a carrier oil, or a non-hop derived flavorant compound.

4. The oil-in-water emulsion composition of claim 1, wherein the flavorant comprises a terpene, a terpene blend, a thiol, a ketone, an ester, an aldehyde, an alcohol, a heterocycles, or a phenolic.

5. The oil-in-water emulsion composition of claim 1 comprising about 0.05% to about 8% by weight, based on the total weight of the emulsion composition, of the flavorant.

6. The oil-in-water emulsion composition of claim 1, wherein the emulsifier adjuvant comprises citric acid, malic acid, tartaric acid, ascorbic acid, sorbic acid, caffeic acid, and ferulic acid, or a salt thereof.

7. The oil-in-water emulsion composition of claim 1, wherein the emulsifier adjuvant comprises one or more of lactose, maltose, sucrose, trehalose, dulcitol, glycerol, mannitol and sorbitol.

8. The oil-in-water emulsion composition of claim 1 comprising about 0.01% to about 15% by weight of the total weight of the emulsion composition, of the emulsifier adjuvant.

9. The oil-in-water emulsion composition of claim 1, wherein the emulsifying agent comprises a phospholipid, potassium sorbate, sorbitan monooleate, sorbitan monolaurate, sorbitan monopalmitate, sorbitan monostearate, sorbitan monostearate, xanthan gum, guar gum, carrageenan, locust bean gum, monoglycerides, diglycerides, medium chain triglycerides, or long chain triglycerides.

10. The oil-in-water emulsion composition of claim 1, wherein the emulsifying agent comprises a sunflower lecithin.

11. The oil-in-water emulsion composition of claim 4 further comprising (a) a flavorant comprising, sunflower oil, medium chain triglycerides, or a combination thereof, and (b) an emulsifier adjuvant comprising trehalose, sucrose, or a combination thereof.

12. The oil-in-water emulsion composition of claim 1, wherein the water is present in an amount corresponding to the remaining balance of material in the oil-in-water emulsion composition.

13. The oil-in-water emulsion composition of claim 1 which exhibits reduction in particle size and/or particle size range, lower turbidity, pH stability, increased stability during storage and shelf life as compared to an otherwise identical formulated composition containing a weighting agent, gum acacia, or a mixture thereof.

14. An oil-in-water emulsion composition comprising:
about 0.5 wt. % to about 8 wt. %, based on a total weight of the emulsion composition, of a flavorant;
about 0.01 wt. % to about 5 wt. %, based on the total weight of the emulsion composition, of a sunflower lecithin;
about 0.01 wt. % to about 0.1 wt. %, based on the total weight of the emulsion composition, of citric acid; and
water in an amount corresponding to the remaining balance based on the total weight of the oil-in-water emulsion composition;
wherein the oil-in-water emulsion composition is substantially free of a weighting agent and/or gum acacia.

15. The oil-in-water emulsion composition of claim 14 which exhibits improved stability as compared to an otherwise identical formulated composition but containing a weighting agent and/or gum acacia.

16. A product comprising the oil-in-water emulsion composition of claim 1, wherein the product is an edible product, a flavor product, or a fragrance product.

17. The product of claim 16, wherein the product is the edible product comprising a food or beverage product.

18. The product of claim 17, wherein the edible product comprises the beverage product, and the beverage product is a fermented beverage.

19. The product of claim 18, wherein the fermented beverage is kombucha, beer, wine, or cider.

20. A method comprising:
providing an oil phase comprising a flavorant;
providing an aqueous phase comprising water, one or more emulsifying agents, and one or more emulsifier adjuvants;
mixing the oil phase and the aqueous phase to obtain a pre-emulsion; and
homogenizing the pre-emulsion to obtain an oil-in-water emulsion;
wherein the oil-in-water emulsion is substantially free of weighting agents and/or gum acacia; and
optionally wherein the homogenizing comprises a multi-stage homogenization process.
